(19) United States
(12) Patent Application Publication
(10) Pub. No.: US 2023/0103038 A1
(43) Pub. Date: Mar. 30, 2023

(54) METHOD FOR DIRECTLY TRANSFERRING ELECTRONIC COIN DATA SETS BETWEEN TERMINALS, PAYMENT SYSTEM, CURRENCY SYSTEM AND MONITORING UNIT

(71) Applicant: GIESECKE+DEVRIENT ADVANCE52 GMBH, Munchen (DE)

(72) Inventors: Tilo FRITZHANNS, Munchen (DE); Florian GAWLAS, Munchen (DE); Wolfram SEIDEMANN, Munchen (DE); Maria VELEVA, Munchen (DE)

(21) Appl. No.: 17/801,973

(22) PCT Filed: Feb. 24, 2021
(86) PCT No.: PCT/EP2021/054544

§ 371 Date: Aug. 24, 2022

(30) Foreign Application Priority Data
Feb. 25, 2020 (DE) 10 2020 104 906.4

(51) Int. Cl. G06Q 20/10; G06Q 20/06; G06Q 20/38; G06Q 20/32; G06F 21/64

(52) U.S. Cl. CPC G06Q 20/10; G06F 21/64; G06Q 20/065; G06Q 20/327; G06Q 20/3823; G06Q 20/3825; G06Q 20/3829; G06Q 2220/00

(57) ABSTRACT

The invention relates to a method for directly transmitting electronic coin datasets between terminals, wherein a first terminal has at least one electronic coin dataset, and the at least one electronic coin dataset has a monetary value and a concealment value. The method has the steps of: determining a masking mode from at least two masking modes, a first masking mode consisting of: masking the electronic coin dataset, preferably in the first terminal, by applying a one-way function to the first coin dataset in order to obtain a completely masked electronic coin dataset; and registering a masked electronic coin dataset in a monitoring entity. The invention additionally relates to a payment system with a monitoring layer using a database, which is controlled in a decentralized manner and in which masked electronic coin datasets are stored, and a direct transaction layer, which uses at least two terminals and in which the method can be carried out.

### TECHNICAL FIELD OF THE INVENTION

The invention relates to a method for directly transferring electronic coin data sets between terminals. The invention further relates to a payment system for exchanging monetary amounts and a currency system.

### TECHNICAL BACKGROUND OF THE INVENTION

Security of payment transactions and associated payment transaction data means both protecting the confidentiality of the exchanged data; and protecting the integrity of the exchanged data; and protecting the availability of the exchanged data.

Traditional blockchain-based payment transactions, such as Bitcoin, present a high level of integrity protection. When electronic coin data sets, or “coins,” change hands in a blockchain technology, a lot of information is made public. Thus, such payment transactions and especially the exchanged data are not completely confidential. In addition, the payment transactions are very computationally intensive and thus energy-intensive.

Therefore, conventionally, instead of the confidential data, only the hash values of the confidential data are often stored in a blockchain ledger. The corresponding plaintext data must then be managed outside the blockchain. So far, such concepts are not applicable to electronic coin data sets because they do not have basic control functions, in particular (1) the detection of multiple spending methods, also called double spending, and (2) the detection of uncovered payments. In case (1) someone tries to spend the same coin data set multiple times and in the second case someone tries to spend a coin data set although he has no credit (anymore).

Systems for transferring monetary amounts in the form of electronic data sets, in which payment with duplicates of the data set is prevented and a high degree of manipulation security is provided, are known from DE 10 2009 038 645 A1 and DE 10 2009 034436 A1, although complex structures and elaborate encryption and signing processes are required here during exchange. These have proved to be of little practical use.

WO 2016/200885 A1 describes a method for encrypting an amount transacted in a blockchain ledger, while obtaining the verifiability of the transaction. Therein an obfuscation amount is added to an input value. Then an output value is generated and encrypted. Both the input value and the output value are within a range of values, where a sum of any two values within the range does not exceed a threshold. The sum of the encoded input value and the encoded output value can be zero. Range checks, called range proofs, are associated with each of the input values and the output value. These range proofs prove that the input value and the output value fall within the range of values. Each public key can be signed with a ring signature based on a public key of a recipient in the transaction. In this method, blockchain technology is required to be called after obtaining a coin data set to validate the coin data set.

It is the object of the present invention to provide a method and a system in which a payment transaction is designed to be secure yet simple. In particular, a direct payment between devices, such as tokens, smartphones, but also machines, such as cash terminals or vending machines, is to be created which is anonymous. The coin data sets should be able to be used immediately after obtaining them, in order to enable payment even without combining them with a DLT. Multiple coin data sets should be able to be combined and/or split at the user’s convenience to allow flexible exchange. The exchanged coin data sets should on the one hand be confidential towards other system participants, but on the other hand allow each system participant to perform basic monitoring checks, in particular the detection of multiple spending attempts and the detection of attempts to pay with non-existent amounts. In the future, it should be possible to dispense with cash (banknotes and analogue coins) altogether, or at least with analogue coins.

Modification, e.g., splitting, combining or switching of electronic coin data sets, should be carried out without high computing costs and with a minimum of data volume for transferring the coin data sets. The verification of the modification should be able to be done securely without costly proofing of corresponding validity (range proofs), in order to increase the degree of flexibility and thus the userfriendliness.

### SUMMARY OF THE INVENTION

The tasks posed are solved with the features of the independent patent claims. Further advantageous embodiments are described in the dependent patent claims.

The task is solved in particular by a method for direct transfer of electronic coin data sets between terminals, wherein a first terminal has at least one electronic coin data set, wherein the at least one electronic coin data set has a monetary amount and an obfuscation amount, comprising the steps: Determining a masking mode from at least two masking modes, wherein a first masking mode comprises: masking the electronic coin data set, preferably in the first terminal, by applying a one-way function, which is for example homomorphic, to the electronic coin data set, preferably to its obfuscation amount, to obtain a fully masked electronic coin data set, and registering a masked electronic coin data set in a monitoring entity.

In a preferred embodiment, a second masking mode comprises: masking the electronic coin data set, preferably in the first terminal, by applying the one-way function to the electronic coin data set and adding a coin data set element, preferably the monetary amount, of the electronic coin data set to obtain an incompletely masked electronic coin data set.

For example, in this preferred embodiment, the added coin data set element is the monetary amount of the electronic coin data set. This obtains an amount-open masked electronic coin data set as the incompletely masked electronic coin data set. With such an electronic coin data set, the monetary amount can be read and interpreted. This means that parts of the masked coin data set are also transferred and registered openly. The method thus remains anonymous, but the monetary amounts transferred can be tracked and registered at any time. The payment process thus remains anonymous, although the amount transfers are transparent.

In a preferred embodiment, a third masking mode comprises: masking the obfuscation amount of the electronic coin data set, preferably in the first terminal, by applying cryptographic function to one of the data set elements, preferably the obfuscation amount, of the electronic coin data set and adding a coin data set element, preferably the monetary amount, of the electronic coin data set to obtain a quasi-masked electronic coin data set. The cryptographic function may be a cryptographic obfuscation function or a cryptographic masking function.

In a preferred embodiment, a fourth masking mode comprises: splitting the monetary amount of the electronic coin data set by place value, preferably in the first terminal, into a first monetary amount part and a second monetary amount part, wherein the base of the place value is arbitrary; replacing the monetary amount with the first monetary amount part in the electronic coin data set; masking the electronic coin data set, preferably in the first terminal, by applying the one-way function to the electronic coin data set and adding the second monetary amount part to obtain a partially masked electronic coin data set. The place value is selected either based on a default value predetermined throughout the process, or randomly, or according to a choice made by the terminal.

In this preferred embodiment, the added coin data set element may be a higher-value amount portion of the monetary amount of the electronic coin data set split locally into the higher-value amount portion and a lower-value amount portion, whereby an electronic coin data set that is amount-open only with respect to the higher-value amount portion is obtained as the incompletely masked electronic coin data set. With such an electronic coin data set, the higher-value amount portion can be read and interpreted. This means that parts of the masked coin data set are also transferred and registered openly. Thus, the method remains anonymous, but the transferred monetary amounts can be tracked and registered at any time. The payment process thus remains anonymous, although the amount transfers are transparent.

Preferably, the incompletely masked electronic coin data set is then masked only with regard to the lower-value amount portion.

The higher-value amount portion represents a portion of the monetary amount that is greater than the portion of the monetary amount that represents the lower-value amount portion. For example, higher-value digits of a data element representing the monetary amount, such as one or more most-significant bits, MSB, may be transferred transparently. Remaining, lower-value digits of the data element representing the monetary amount are masked.

In a preferred embodiment, the step of registering is, depending on the determined masking mode, either registering the fully masked electronic coin data set (for the first masking mode) or the incompletely masked electronic coin data set (for the second masking mode) or the quasi-masked electronic coin data set (for the third masking mode) or the partially masked electronic coin data set in the monitoring entity (for the fourth masking mode).

The determination or selection of the masking mode can be predefined in the method, for example by the monitoring entity or a third-party provider (wallet provider). This would provide a method in which the masking mode is fixed.

Alternatively, the step of determining could be done by selecting the masking mode in the first terminal. This would provide an agile method in which the respective terminal determines or selects the masking mode itself or provides a user of the terminal with an option for selection.

In a preferred embodiment, a parameter for determining the masking mode is specified by the monitoring entity or a service provider. Preferably, the terminal then selects the masking mode based on this parameter. Thus, a terminal is set up to decide which masking module is selected or determined depending on the situation on the basis of the parameter. A parameter for specifying the masking mode could be, for example, a minimum computing power of the terminal or a maximum time period for masking and registering the coin data set or a degree of secrecy for the coin data set. In particular, this may allow another terminal different from the first terminal to select a different masking mode to comply with the default parameter.

In a preferred embodiment, one masking mode is changed to another masking mode for an electronic coin data set by the terminal. This provides interoperability, in particular between a fully masked, an incompletely masked, a quasi-masked and a partially masked electronic coin data set, thereby increasing the flexibility of transfer. For example, an incompletely masked coin data set can be combined with a partially masked coin data set after switching or combining the incompletely masked coin data set with a coin data set of monetary value 0, thereby creating a partially masked electronic coin data set and subsequently combining two partially masked electronic coin data sets; see also the discussion below regarding “switching” or “combining” with respect to modifying an electronic coin data set.

The steps described here do not have to be performed in the order described. However, the sequence described herein is a preferred embodiment.

An electronic coin data set is an electronic data set represented by coin data set elements. In particular, it is an electronic data set that represents a monetary amount and is also colloquially referred to as a “digital coin” or “electronic coin”. This monetary amount changes in the method from a first terminal to another terminal. In the following, a monetary amount as a data set element is understood to be a digital amount that can, for example, be credited to an account of a financial institution or exchanged for another means of payment. An electronic coin data set thus represents cash in electronic form.

The terminal may have a plurality of electronic coin data sets, for example, the plurality of coin data sets may be stored in a data memory of the terminal. The data memory then represents, for example, an electronic purse. The data memory may, for example, be internal, external or virtual. In one embodiment, when an electronic data sets is received, an automatic “combining” may take place so that preferably only one (or a certain number of) electronic data set(s) are in the terminal.

For example, the terminal may be a passive device such as a token, a mobile terminal such as a smartphone, a tablet computer, a computer, a server or a machine.

An electronic coin data set for transferring monetary amounts is substantially different from an electronic data set for exchanging or transferring data, for example, because a traditional data transaction is based on a question-answer principle or on intercommunication between the data transfer parties. An electronic coin data set, on the other hand, is unique and stands in the context of a security concept, which can comprise signatures or encryption, for example. In principle, an electronic coin data set includes all the data required by a receiving entity for verification, authentication and forwarding to other entities. Intercommunication between terminals during exchange is therefore basically not required for this type of data set.

Preferably, the electronic coin data set is transferred from the first terminal to a second terminal.

According to the invention, an electronic coin data set used for transfer between two terminals has a monetary amount, as a data set element representing a monetary value of the electronic coin data set, and an obfuscation amount, as a data set element, for example a random number. In addition, the electronic coin data set may have other data set elements, such as metadata, representing, for example, currency of the monetary amount. An electronic coin data set is uniquely represented by these at least two data set elements (monetary amount and obfuscation amount). Anyone who has access to these at least two data set elements of a valid electronic coin data set can use this electronic coin data set for payment. Knowing these two data set elements (monetary amount and obfuscation amount) is therefore equivalent to possessing the digital money. This electronic coin data set is transferred directly between two terminals. In one embodiment of the invention, an electronic coin data set consists of these two data set elements, thus only the transfer of the monetary amount and the obfuscation amount is necessary to exchange digital money.

A corresponding masked electronic coin data set is assigned to each electronic coin data set. This masked electronic coin data set may be a fully masked electronic coin data set (first masking mode) or an incompletely masked electronic coin data set (second masking mode) or a quasi-masked electronic coin data set (third masking mode) or a partially masked electronic coin data set (fourth masking mode).

A fully masked electronic coin data set (first masking mode) is a masked electronic coin data set whose entirety of data set elements is masked. In particular, the fully masked electronic coin data set does not comprise any unmasked data set element. No (unmasked) data set element of the electronic coin data set can be directly extracted/read from the fully masked electronic coin data set.

An incompletely masked electronic coin data set (second masking mode) is a masked electronic coin data set in which at least one data set element is (also) included unmasked. At least one (unmasked) data set element of the electronic coin data set can be taken directly from the incompletely masked electronic coin data set. The unmasked data set element can be added to a corresponding fully masked electronic coin data set to obtain the incompletely masked coin data set. In this preferred case, the data set element is then included in unmasked form and in masked form in the incompletely masked coin data set.

A quasi-masked electronic coin data set (third masking mode) is a masked electronic coin data set in which at least one data set element of the (unmasked) electronic coin data set is included in cryptographically encrypted form. The quasi-masked electronic coin data set is applied by applying a cryptographic encryption function to at least one of the data set elements, preferably the obfuscation amount. The quasi-masked electronic coin data set comprises, in addition to the encrypted data set element, in particular also at least one unmasked data set element, in particular the monetary amount. At least one (unmasked) data set element of the electronic coin data set can be taken directly from the quasi-masked electronic coin data set. The unmasked data set element may be added to the encoded data set element to obtain the quasi-masked coin data set.

A partially masked electronic coin data set (fourth masking mode) is a masked electronic coin data set in which at least one data set element and a first monetary amount part of the electronic coin data set are included in cryptographically encrypted form. The partially masked electronic coin data set also comprises an unmasked data set element, in particular the second monetary amount part. The first monetary amount part and the second monetary amount part have been included by splitting the monetary amount of the electronic coin data set by place value, see further explanations on place value and basis given below. The first monetary amount part thus obtained replaces the monetary amount in the electronic coin data set for the masking step. The second monetary amount part is then added unmasked to the masked electronic coin data set. Thus, at least the second monetary amount part of the electronic coin data set can be taken directly from the partially masked electronic coin data set.

In the following, the term “masked electronic coin data set” will always be used for simplified purposes if a statement applies equally to both a fully masked electronic coin data set and an incompletely masked electronic coin data set, i.e. also to a quasi-masked electronic coin data set and a partially masked electronic coin data set.

Knowledge of a masked electronic coin data set does not authorize the issuance of the digital money represented by the electronic coin data set. This represents a key difference between masked electronic coin data sets and (non-masked) electronic coin data sets and is a core feature of the present invention. The masked electronic coin data set is unique and uniquely associated with an electronic coin data set, thus there is a 1-to-1 relationship between the (non-masked) electronic coin data set and the masked electronic coin data set. Masking of the electronic coin data set is preferably performed by a computing unit of the terminal within the terminal that also has the at least one electronic coin data set. Alternatively, masking may be performed by a computing unit of the terminal receiving the electronic coin data set.

The masked electronic coin data set is obtained by applying a one-way function, such as a homomorphic one-way function, such as a cryptographic function. This function is a one-way function, that is, a mathematical function that is “easy” to compute in terms of complexity theory, but “difficult” to practically impossible to reverse. Here, the term one-way function is also used to describe a function for which no inversion is known that can be practically executed in a reasonable amount of time and with a reasonable amount of effort. Thus, calculating a masked electronic coin data set from an electronic coin data set is comparable to or equivalent to generating a public key in an encryption process via a residue class group. Preferably, a one-way function is used that operates on a group in which the discrete logarithm problem is difficult to solve, such as a cryptographic method analogous to elliptic curve encryption, or ECC, from a private key of a corresponding cryptographic method. The reverse function, i.e. the generation of an electronic coin data set from a masked electronic coin data set (or the part of the electronic coin data set) is thereby – equivalent to the generation of the private key from a public key in an encryption procedure via a residue class group – very time-consuming. When sums and differences or other mathematical operations are referred to in the present document, they are to be understood in the mathematical sense as the respective operations on the corresponding mathematical group, for example the group of points on an elliptic curve.

In one embodiment, the one-way function is homomorphic, i.e., a cryptographic method that has homomorphism properties. Thus, mathematical operations can be performed on the masked electronic coin data set that can also be performed in parallel on the (unmasked) electronic coin data set and thus be traced. Using the homomorphic one-way function, calculations with masked electronic coin data sets can be traced in the monitoring entity without the corresponding (unmasked) electronic coin data sets being known there. Therefore, certain calculations with electronic coin data sets, for example for a modification of the (unmasked) electronic coin data set (for example splitting or combining), can also be proven in parallel with the corresponding masked electronic coin data sets, for example for validation checks or for monitoring about the legitimacy of the respective electronic coin data set. The homomorphism properties apply at least to addition and subtraction operations, so that a splitting or combining (=combining) of electronic coin data sets can also be recorded by means of the corresponding masked electronic coin data sets in the monitoring entity and can be traced by requesting terminals and/or by the monitoring entity without gaining knowledge about the monetary amount and the performing terminal.

The homomorphism property thus allows a record of valid and invalid electronic coin data sets based on their masked electronic coin data sets to be maintained in a monitoring entity without knowledge of the electronic coin data sets, even if those electronic coin data sets are modified (split, combined, switched). This ensures that no additional monetary amount has been created or that an identity of the terminal is held in the monitoring entity. Masking enables a high level of security without providing visibility into the monetary amount or the terminal. This results in a two-layer payment system. On the one hand, there is the processing layer, in which masked electronic data sets are checked, and on the other hand, there is the direct transaction layer, in which at least two terminals transfer electronic coin data sets.

In a further embodiment, the one-way function is a cryptographic encryption function.

Applying the one-way function to the electronic coin data set also comprises applying the one-way function to a portion of the electronic coin data set, in particular to the obfuscation amount, in one embodiment only to the obfuscation amount.

Obtaining the quasi-masked electronic coin data set is performed by applying a cryptographic obfuscation function to a data set element (preferably the obfuscation amount) of the (unmasked) electronic coin data set. An obfuscation method can be used to convert the data set element into an obfuscated data set element (secret element). The obfuscation amount can be used as a dynamic key for encryption. The obfuscation amount cannot be used as a key for decryption.

When transferring an electronic coin data set from the first terminal to the second terminal, two terminals have knowledge of the electronic coin data set. In order to prevent the first terminal from using the electronic coin data set for payment at another (third) terminal (so-called double spending), it is preferable to perform a switch (“switch”) of the transferred electronic coin data set from the first terminal to the second terminal. The switch can preferably be performed automatically when an electronic coin data set is received in the second terminal. Additionally, it may also occur upon request, such as a command from the first and/or second terminal. Additionally, an electronic coin partial data set may also be split into at least two coin partial data sets (“split”). Additionally, two electronic coin data sets can be combined into one coin data set (“merge”).

Switching, splitting and combining are different modifications to an electronic coin data set. These modifications require registering the masked coin data set in a monitoring entity. This registering in the course of the modifications causes the electronic coin data set sent by the first terminal to become invalid and to be recognized as correspondingly invalid when the first terminal makes a second output attempt. The coin data set to be registered by the second terminal becomes valid by being registered in the monitoring entity. The specific performance of each modification will be explained later.

Switching is also performed when an electronic coin data set has been modified, for example, split or combined with other electronic coin data sets, in particular to suitably settle a monetary amount to be paid.

For the modification of electronic coin data sets (switching, splitting, combining), the monitoring entity checks whether the (masked) electronic coin data set has a valid range. For this purpose, so-called “zero-knowledge range proofs” are applied as range verification. Range proofs allow, on the one hand, that a changed monetary amount (split, combine) is within a predefined range of valid monetary amounts and, on the other hand, that ownership of the monetary amounts to be changed is proven. One proof is the representation of the monetary amount in binary format and the representation based on it as a ring signature.

This proof management requires a not small volume of data to be exchanged between the terminal and the monitoring entity and a computational effort. It is desirable that such verifications can be performed in a substantially simplified manner.

In the method according to the invention, therefore, an improved masking of the at least one electronic coin data set is provided in order to simplify the range verifications.

According to the invention, a selection of a masking mode is made or a masking mode is determined before the transfer step and/or before the register step. The selection is made, for example, by a user of the first terminal via a corresponding menu control on the terminal. The selection is made, for example, on the basis of a system default in the payment system or a system default by a third-party provider. For example, a performance of the payment system can be optimally utilized in this way, so that an effort of verification based on a current registration request volume in the monitoring entity can be controlled by selecting the masking mode accordingly. The selection can also be selected based on a terminal property. For example, in the absence of support for one of the masking modes, a corresponding preselection can be made.

According to the selection made by the terminal, a range proof is created when registering in the monitoring entity. This also includes the place value representation of the monetary amount to any base, for example to base 2 (binary) or base 3 (ternary), etc.

The different four masking modes allow various range checking options to be realised:

For example, there is no simplification (shortening) of the range verification if this option is not implemented in the system, the monitoring entity or the terminal. Then, the verification is performed over the entire range of the monetary amount.

Alternatively, the range verification simplification according to a fixed default value is mandatory in the system in case of a modification (switching, splitting, combining) of a coin data set.

Alternatively, the area verification simplification is optionally provided with a fixed default value. In this case, the monitoring entity can determine whether a fully masked electronic coin data set or an incompletely masked electronic coin data set or a quasi-masked electronic coin data set or a partially masked electronic coin data set is to be generated and whether a change from one masking type to another masking type is to be made.

Alternatively, the range verification shortening is optional with a variable default value. This allows the user to determine how much of the masked coin data set is to be disclosed within the allowed system defaults. The variable default value can be changed again with each modification to the coin data set.

To improve the performance of the method, the fourth masking mode abbreviates the range verification by applying a ring signature only to the first monetary amount part that corresponds to a default value (system default or terminal selection).

The decision on the extent to which data elements are transferred unmasked, e.g. the extent to which information about the electronic coin data set is transparent or hidden to a monitoring entity, could be based on a decision by the terminals transferring the respective coin data sets. To describe this negotiation of the decision, the terms “fully masked coin data set” and “incompletely masked coin data set” introduced above are used.

The fully masked coin data set is associated with an (unmasked) private electronic coin data set, which hides all data elements, in particular the monetary amount, from the monitoring entity. For such private electronic coin data sets, the first masking mode shall be selected.

The incompletely masked coin data set is associated with an (unmasked) semi-private electronic coin data set that discloses at least one data element, for example the monetary amount, to the verification level (monitoring entity). For such semi-private electronic coin data sets, the first or the second masking mode can be selected.

The partially masked coin data set is associated with an (unmasked) semi-private electronic coin data set that discloses the second monetary amount part to the verification level (monitoring entity). The fourth masking mode can be selected for such semi-private electronic coin data sets.

The use of private electronic coin data sets in a modify step together with semi-private electronic coin data sets is not problematic. A corresponding switch of a private electronic coin data set into a semi-private electronic coin data set is made possible with a switching step as described below for the second masking mode.

The reverse case, i.e. using semi-private electronic coin data sets in a modifying step together with private electronic coin data sets, requires an additional masking step as described in a combining or splitting step in the first masking mode.

When combining to convert a semi-private to a private electronic coin data set, an additional private electronic coin data set is required. If no additional private electronic coin data set is currently present in the respective terminal, a private zero coin electronic data set is used that has a monetary amount of zero but an obfuscation amount, i.e., does not represent a monetary amount. This private zero coin data set can be created at any time from a single existing private electronic coin data set using a split step. In this particular split step, a first private coin partial data set is generated that has the same monetary amount as the single existing private electronic coin data set, and a second coin partial data set is generated that is a zero coin electronic data set. This split to obtain the private electronic zero coin data set is performed before the semi-private coin data set is transferred to the private electronic coin data set and stored for later use.

For example, for registering in the second, third or fourth masking mode, the monetary amount or a monetary amount part is transferred unmasked. However, the corresponding masking modes are not limited to the unmasked transfer of the monetary amount (part), any other data set element (part) could alternatively or additionally be transferred unmasked. This eliminates the need to transmit additional data packets for complex range verification or increases the performance in the fourth masking mode by using much smaller data packets.

If the monetary amounts (or amount parts) are transferred unmasked or unveiled, the range verification is simplified to only two verification steps, namely (1) whether the monetary amount added to the incompletely masked electronic coin data set belongs to this masked electronic coin data set and (2) whether the ownership of the modified (unmasked) electronic coin data set is proven. In the fourth masking mode, only an abbreviated range verification needs to be checked.

These simplifications cause changes in the range checking for the modifications (split, combine, switch), as explained below.

In a preferred embodiment of the method, the further method steps are provided in the second terminal after transfer: switching the electronic coin data set while generating an electronic coin data set to be switched in the terminal from the electronic coin data set, wherein an obfuscation amount for the electronic coin data set to be switched is generated using the obfuscation amount of the electronic coin data set in the second terminal; and the monetary amount of the electronic coin data set is used as a monetary amount for the electronic coin data set to be switched.

Alternatively or additionally provided is: splitting the electronic coin data set into a first electronic coin partial data set and a second electronic coin partial data set in the first terminal, wherein the monetary amount is split into at least a first monetary amount and a second monetary amount.

Alternatively or additionally provided is: combining a first and a second electronic coin data set into a combined electronic coin data set in the first terminal, comprising the steps of: calculating an obfuscation amount for the electronic coin data set to be combined by forming the sum of the respective obfuscation amounts of the first and second electronic coin data sets; and calculating the monetary amount for the electronic coin data set to be combined by forming the sum of the respective monetary amounts of the first and second electronic coin data sets.

In all three described method steps, i.e. switching, splitting and combining, masking the electronic coin data set in the masking step of the first or second masking mode comprises masking the coin data set to be switched of the first and/or second coin partial data set and/or the combined coin data set.

When masking the electronic coin data set in the masking step of the third or fourth masking mode, a data set element, for example the obfuscation amount of the respective electronic coin data set, is used as a dynamic private key, but with which no decryption is possible.

Subsequently, for all four masking modes, the fully masked electronic coin data set or the incompletely masked electronic coin data set or the quasi-masked electronic coin data set or the partially masked electronic coin data set is transmitted to the monitoring entity for checking the validity of the electronic coin data set by the monitoring entity. Checking the validity is explained in detail below.

In a preferred embodiment, the method has the further method steps of: Generating a signature using the obfuscation amount of the electronic coin data set; Adding the signature to the masked electronic coin data set, in particular the incompletely masked electronic coin data set or the quasi-masked electronic coin data set, wherein the fully masked electronic coin data set or the incompletely masked electronic coin data set or the quasi-masked electronic coin data set is registered with the signature in the monitoring entity.

Preferably, after the switching step, the registering step comprises in the monitoring entity for the first, second and/or fourth masking mode: Receiving the incompletely masked electronic coin data set to be switched or the fully masked electronic coin data set to be switched or the partially masked electronic coin data set to be switched in the monitoring entity; checking the masked electronic coin data set for validity in the monitoring entity; calculating the difference between the incompletely masked coin data set to be switched or the fully masked coin data set to be switched or the partially masked electronic coin data set and the masked electronic coin data set and checking by means of a signature added to the incompletely masked electronic coin data set or the fully masked electronic coin data set and generated by generating a public verification key; checking a full or abbreviated range verification; and registering the masked electronic coin data set to be switched in the monitoring entity if all checking steps are successful and a simplified range verification has been performed, whereby the electronic coin data set to be switched is considered valid.

Preferably, the method comprises, after the switching step, the registering step in the monitoring entity for the second and/or third masking mode: Receiving the quasi-masked electronic coin data set to be switched in the monitoring entity; Checking the quasi-masked electronic coin data set for validity in the monitoring entity; Checking whether the monetary amount of the electronic coin data set is equal to the monetary amount of the electronic coin data set to be switched; calculating the difference between the quasi-masked coin data set to be switched and the quasi-masked electronic coin data set; checking by means of an added signature created by generating a public verification key; and registering the quasi-masked electronic coin data set to be switched in the monitoring entity if all checking steps are successful, whereby the electronic coin data set to be switched is considered valid.

Preferably, after the splitting step, the registering step in the monitoring entity comprises for the first, second and/or fourth masking mode: Receiving the incompletely masked electronic coin data set or the fully masked electronic coin data set or the partially masked electronic coin data set in the monitoring entity; Checking the masked electronic coin data set to be switched for validity in the monitoring entity; checking a ring signature added to the incompletely masked electronic coin data set or the partially masked electronic coin data set using the monetary amount of the electronic coin data set in the monitoring entity; calculating the difference between the sum of the fully masked electronic coin data sets or the sum of the incompletely masked electronic coin data sets or the sum of the partially masked electronic coin data sets and the masked coin data set to check whether the monetary amount of the electronic coin data set is equal to the sum of the first and second monetary amounts of the respective electronic coin data sets to check whether the monetary amount of the electronic coin data set is equal to the monetary amount of the electronic coin data set to be switched; and registering the masked electronic coin partial data sets in the monitoring entity if all checking steps are successful and simplified range verification has occurred, whereby the electronic coin partial data sets are deemed valid.

Preferably, the method comprises, after the splitting step, the registering step in the monitoring entity for the second and/or the third masking mode: Receiving the incompletely masked electronic coin partial data sets in the monitoring entity; Checking the masked electronic coin data set to be switched for validity in the monitoring entity; Checking a signature added to the incompletely masked electronic coin data set by generating a public verification key; calculating the sum of the monetary amounts of the coin partial data sets to check whether the monetary amount of the electronic coin data set is equal to the sum of the first and second monetary amounts of the electronic coin partial data sets; and registering the masked electronic coin partial data sets in the monitoring entity if all checking steps are successful and a simplified range verification has been performed, whereby the electronic coin partial data sets are considered valid.

Preferably, after the combining step, the registering step in the monitoring entity comprises for the first, second and/or fourth masking mode: Receiving the incompletely masked connected electronic coin data set or the fully masked connected electronic coin data set in the monitoring entity; checking the masked first and second electronic coin data sets for validity in the monitoring entity; checking a first ring signature added to the incompletely masked electronic coin data set or the fully masked electronic coin data set using the first monetary amount of the first electronic coin data set in the monitoring entity; checking a second ring signature added to the incompletely masked electronic coin data set or the fully masked electronic coin data set using the second monetary amount of the second electronic coin data set in the monitoring entity; calculating the difference between the incompletely masked linked electronic coin data set or the fully masked linked electronic coin data set and the sum of the masked first electronic coin data set and the masked second electronic coin data set to check whether the monetary amount of the linked electronic coin data set is equal to the sum of the first and second monetary amounts of the first and second electronic coin data sets; registering the masked linked electronic coin data set in the monitoring entity if all checking steps are successful and a simplified range verification has been performed, whereby the linked electronic coin data set is deemed valid.

Preferably, the method comprises, after the step of combining, the step of registering in the monitoring entity for the second and/or third masking mode: receiving the incompletely masked combined electronic coin data set in the monitoring entity; checking the masked first and second electronic coin data sets for validity in the monitoring entity; checking a first signature added to the incompletely masked electronic coin data set by generating a first public verification key in the monitoring entity; checking a second signature added to the incompletely masked electronic coin data set by generating a second public verification key in the monitoring entity; calculating the difference between the monetary value of the coin data set to be validated and the sum of the monetary values of the first electronic coin data set and the second electronic coin data set to be combined; registering the masked combined electronic coin data set in the monitoring entity if all checking steps are successful and a simplified range verification has been performed, whereby the combined electronic coin data set is considered valid.

Preferably, the method according to the fourth selection mode comprises a step of generating a verification in the first terminal, the verification comprising information that the monetary amount of the electronic coin data set is positive and known to the creator of the verification, hereinafter also referred to as simplified range verification, with: splitting the electronic coin data set in the first terminal, according to a fixed or variable default value, into a first electronic coin partial data set and a second electronic coin partial data set; splitting the second electronic coin partial data set in the first terminal according to a place value, wherein a place value of the split second electronic coin partial data set represents a place value of the second monetary amount of the electronic coin data set and the sum of all obfuscation amounts of the second electronic coin partial data set split according to a place value results in the obfuscation amount of the electronic coin data set, wherein the basis of the place value is arbitrary.

Based on the place value split of the second electronic coin data set, the terminal generates a ring signature which is transmitted to the monitoring unit together with the partially masked electronic coin data set and is checked there.

Preferably, the base of the place value is two or three. Place value refers to a power of the base of a place value system. Thus, a binary system, is a place value system with a base of 2, a ternary system is a place value system with a base of 3, and a decimal system is a place value system with a base of 10. The value of the base is not determined in this case, in order to enable the most flexible possible place value-based split for a simplified verification check.

For example, the place value-based split is based on a default value. This default value specifies, for example, the point at which the monetary amount is to be split. It then corresponds, for example, to a number of “least significant bits, LSB” if the place value has the base 2. This number of LSB is then added to the partially masked coin data set as the second monetary amount part. The remaining digits of the monetary amount form the first monetary amount part and replace the monetary amount for the masking step.

Alternatively, this default value corresponds to, for example, a number of “most significant bits, MSB” if the place value has a base of 2. This number of MSB is then added to the partially masked coin data set as the second monetary amount part. The remaining digits of the monetary amount form the first monetary amount part and replace the monetary amount for the masking step.

Alternatively, this default value corresponds to a random number of bits, for example, if the place value has a base of 2. This number of bits is then added to the partially masked coin data set as the second monetary amount part. The remaining digits of the monetary amount form the first monetary amount part and replace the monetary amount for the masking step.

Alternatively, this default value corresponds to a concrete selection of bits, for example, if the place value has a base of 2. This selection of bits is then added to the partially masked coin data set as the second monetary amount part. The remaining digits of the monetary amount form the first monetary amount part and replace the monetary amount for the masking step.

The verification is preferably based on ring signatures whose parameters require the generation of random numbers and the derivation of scatter values (hash) in the terminals.

A default value defined for verification can be a system-defined parameter – as described above – or the result of a negotiation between two system participants (terminals or monitoring entity).

The following explanations are given with regard to the third masking mode and the quasi-masked coin data sets created in this mode. A prerequisite for selecting the third masking mode is that there is no need in the system to mask (hide) a data element, such as the monetary amount. This lack of need greatly simplifies the entire payment system and the method of exchanging coin data sets directly between terminals. An electronic coin data set, as described above and comprising at least a monetary amount and an obfuscation amount as data elements, can then be associated with a quasi-masked electronic coin data set consisting of, for example, the unmasked monetary amount and the encrypted obfuscation amount. All modifications (splitting, switching, combining) can also be applied to these quasi-masked electronic coin data sets and are dealt with in the context of the third masking mode hereafter. The explanations for the third masking mode represent alternative designs to the first or second masking mode, but can be combined with each other as desired with regard to signature creation, choice of encryptions, choice of verification checks. The general aim of a combination is to obtain a substantial simplification of the range-proofs (range-proofs).

Preferably, after the switching step, the registering step takes place in the monitoring entity for the third masking mode with: receiving the quasi-masked electronic coin data set to be switched in the monitoring entity; checking the quasi-masked electronic coin data set for validity in the monitoring entity; checking a signature added to the quasi-masked electronic coin data set using the encrypted obfuscation amount of the electronic coin data set in the monitoring entity; and registering the quasi-masked electronic coin data set to be switched in the monitoring entity if the two checking steps are successful, whereby the electronic coin data set to be switched is deemed valid.

Preferably, after the splitting step, the registering step is performed in the monitoring entity for the third masking mode with: Receiving the quasi-masked electronic coin partial data set in the monitoring entity; Checking the quasi-masked electronic coin partial data set for validity in the monitoring entity; Checking a signature added to the quasi-masked electronic coin partial data set using the masked obfuscation amount in the monitoring entity; checking that the monetary amount of the electronic coin data set is equal to the sum of the first and second monetary amounts of the electronic coin partial data sets; registering the quasi-masked electronic coin partial data sets in the monitoring entity if the three checking steps are successful, whereby the electronic coin partial data sets are deemed valid and the electronic coin data set to be split is deemed invalid.

Preferably, after the combining step, the registering step occurs in the monitoring entity for the third masking mode with: Receiving the quasi-masked combined electronic coin data set in the monitoring entity; Checking the quasi-masked first and second electronic coin data sets for validity in the monitoring entity; Checking two signatures added to the quasi-masked combined electronic coin data sets to be combined using the masked obfuscation amounts in the monitoring entity; checking that the monetary amount of the combined electronic coin data set is equal to the sum of the first and second monetary amounts of the first and second electronic coin data sets; registering the quasi-masked combined electronic coin data set in the monitoring entity if the three checking steps are successful, whereby the combined electronic coin data set is deemed valid and the two electronic coin data sets to be combined are deemed invalid.

The step of checking the quasi-masked coin data sets in the switching, splitting, or combining step is done according to the checking of validity.

Preferably, a signature is created for each quasi-masked electronic coin data set. The private signature key is preferably the (unmasked) obfuscation amount of the (unmasked) coin data set.

The signature is preferably created during the switching step over the quasi-masked electronic coin data set and the encrypted obfuscation amount of the quasi-masked electronic coin data set to be switched.

The signature is preferably created in the split step over the quasi-masked electronic coin partial data set, the quasi-masked first electronic coin partial data set, and the quasi-masked second electronic coin partial data set.

The signature is preferably created during the combining step over the quasi-masked first electronic coin data set, the quasi-masked second electronic coin data set, and the quasi-masked combined electronic coin data set.

For the creation of an unmasked electronic coin data set for the third masking mode, a signature of the issuer is deposited in the monitoring entity via the quasi-masked electronic coin data set.

Deletion of a quasi-masked electronic coin data set occurs when the monitoring entity has checked the signature of an issuing entity.

The signature generated in this method replaces any additional information that would otherwise be required to maintain a range verification on the masked electronic coin data set to be split or a range verification on respective masked electronic coin partial data sets.

To generate the signature, an asymmetric cryptosystem is preferred, in which the terminal calculates a value for a data set using a secret signature key, hereinafter also referred to as a private signature key or “private key”. This value enables anyone to check the authorship and integrity of the data set with the help of a public verification key, the public key.

For example, the signature added in this method for the second and third masking modes is a first signature and a private signature key for generating the first signature is the obfuscation amount of the corresponding electronic coin data set. In contrast, only two signatures are used for the first masking mode, namely the central bank signature for generating and deleting (=fixed private key) and the signature for switching (obfuscation amount as private key).

For example, the signature added in this method (of all masking modes) is a second signature and a private signature key for generating the second signature is generated from a difference between the obfuscation amount of the electronic coin data set and the obfuscation amount for the electronic coin data set to be switched.

A public verification key for checking the first signature is preferably formed from a difference of the masked electronic coin data set and an applying the cryptographic encryption function to the monetary amount of the electronic coin data set.

A public verification key for checking the second signature is preferably formed from a difference between the masked electronic coin data set to be switched and the masked electronic coin data set.

The method preferably has the further following steps: switching the transferred electronic coin partial data set; and/or combining the transferred electronic coin data set with a second electronic coin data set to form a further electronic coin data set, namely combined electronic coin data set.

Upon switching, the electronic coin partial data set obtained from the first terminal results in a new electronic coin data set, preferably with the same monetary amount, called the electronic coin data set to be switched. The new electronic coin data set is generated by the second terminal, preferably by using the monetary amount of the obtained electronic coin data set as the monetary amount of the electronic coin data set to be switched. In the process, a new obfuscation amount, such as a random number, is generated. The new obfuscation amount is added to the obfuscation amount of the obtained electronic coin data set, for example, so that the sum of both obfuscation amounts (new and obtained) serves as the obfuscation amount of the electronic coin data set to be switched. After switching, the obtained electronic coin partial data set and the electronic coin partial data set to be switched are preferably masked in the terminal by applying the one-way function to each of the obtained electronic coin partial data set and the electronic coin partial data set to be switched to obtain a masked received electronic coin partial data set and a masked electronic coin partial data set to be switched, respectively.

Newly created obfuscation amounts must have high entropy since they are used as a blinding factor for the corresponding masked electronic coin partial data sets. Preferably, a random number generator on the terminal is used for this purpose.

Previously, additional information needed to register the switching of the masked electronic coin data set in the remote monitoring entity was preferably calculated in the terminal as part of the switching process. Preferably, the additional information includes a range verification on the masked electronic coin data set to be switched and a range verification on the masked obtained electronic coin data set. The range verification is a verification that the monetary amount of the electronic coin data set is non-negative, the electronic coin data set is validly created, and/or the monetary amount and obfuscation amount of the electronic coin data set are known to the creator of the range verification. Specifically, the range verification is used to provide such proof(s) without revealing the monetary value and/or obfuscation amount of the masked electronic coin data set. These range verifications are also called “zero-knowledge range proofs.” Preferably, ring signatures are used as range verification. This is followed by registering the switching of the masked electronic coin data set in the remote monitoring entity.

Thus, the switching is secured by adding a new obfuscation amount to the obfuscation amount of the received electronic coin data set, thereby obtaining an obfuscation amount known only to the second terminal. However, newly created obfuscation amounts must have a high entropy since they are used as a blinding factor for the corresponding masked electronic coin partial data sets. Preferably, a random number generator on the terminal is used for this purpose. This safeguarding can be tracked in the monitoring entity.

Furthermore, the method comprises the following steps: Masking the coin partial electronic data set to be switched in the second terminal by applying, for example, the homomorphic one-way function to the coin partial electronic data set to be switched to obtain a masked coin partial electronic data set; and registering the masked coin partial electronic data set in a remote monitoring entity.

The steps described herein need not be performed in the order described. However, the sequence described herein is a preferred embodiment.

Preferably, the step of registering is performed when the second terminal is combined with the monitoring entity. While the electronic coin data sets are used for direct payment between two terminals, the masked coin data sets are registered in the monitoring entity, allowing modifications to the masked electronic coin data sets to be registered in the monitoring entity.

In a further preferred embodiment of the method, for a combining of electronic coin partial data sets, a further electronic coin data set (combined electronic coin data set) is determined from a first and a second electronic coin partial data set. Thereby, the obfuscation amount for the electronic coin data set to be combined is calculated by forming the sum of the respective obfuscation amounts of the first and the second electronic coin data set. Further, preferably, the monetary amount for the combined electronic coin data set is calculated by forming the sum of the respective monetary amounts of the first and second electronic coin data sets.

After combining, the first electronic coin partial data set, the second electronic coin partial data set, as well as the electronic coin partial data set to be combined in the (first and/or second) terminal by applying the, for example, homomorphic one-way function to each of the first electronic coin partial data set, the second electronic coin partial data set, as well as the electronic coin data set to be combined, in order to obtain a masked first electronic coin partial data set, a masked second electronic coin partial data set, as well as a masked electronic coin data set to be combined, respectively. Further, additional information needed to register the combining of the masked electronic coin data sets in the remote monitoring entity is calculated in the terminal. Preferably, the additional information includes a range verification on the masked first electronic coin partial data set and a range verification on the masked second electronic coin partial data set. The range verification is a verification that the monetary amount of the electronic coin data set is non-negative, the electronic coin data set is validly created, and/or the monetary amount and obfuscation amount of the electronic coin data set are known to the creator of the range verification. Specifically, the range verification is used to provide such proof(s) without revealing the monetary value and/or obfuscation amount of the masked electronic coin data set. These range verifications are also called “zero-knowledge range proofs.” Preferably, ring signatures are used as range verification. This is followed by registering the combining of the two masked electronic coin partial data sets in the remote monitoring entity.

With the step of combining, two electronic coin data sets or two electronic coin partial data sets can be combined. In this process, the monetary amounts as well as the obfuscation amounts are added together. Thus, as with splitting, validity of the two original coin data sets can be performed during combining.

In a preferred embodiment, the registering step comprises receiving the masked coin partial electronic data set to be switched in the monitoring entity, checking the masked coin partial electronic data set to be switched for validity; and registering the masked coin partial electronic data set to be switched in the monitoring entity if the checking step is successful, whereby the coin partial electronic data set to be switched is deemed to be checked.

Preferably, the checking step determines whether the difference between the masked electronic coin partial data set and the masked electronic coin partial data set to be switched is equal to a public verification key of the signature. This allows easy checking of the validity of the coin partial data set without complex zero-knowledge proofs. However, the zero-knowledge proof is still needed to prove an ownership of the electronic coin data set (except in the third masking mode).

A main distinguishing feature of this invention concept compared to known solutions is that the monitoring entity only (i.e. exclusively) keeps knowledge of the masked electronic coin data set/coin partial data set and a list of processing/modifications to the masked electronic coin data set/coin partial data set. The actual payment transactions with the (unmasked) coin data sets/coin partial data sets are not registered in the monitoring entity and take place in a direct transaction layer directly between terminals.

According to the invention, a two-layer payment system consisting of a direct payment transaction layer, for the direct exchange of (unmasked) electronic coin data sets, and a monitoring layer, which may also be referred to as an “obfuscated electronic data set ledger”, is also provided. In the monitoring entity, the monitoring layer, no payment transactions are recorded, but only masked electronic coin data sets and their processing for the purpose of verifying the validity of (unmasked) electronic coin data sets. This ensures the anonymity of the participants in the payment system. The monitoring entity provides information about valid and invalid electronic coin data sets, for example, to avoid multiple issuance of the same electronic coin data set or to verify the authenticity of the electronic coin data set as validly issued electronic money.

The terminal can thus transfer electronic coin data sets to another terminal in the direct payment transaction layer without a connection to the monitoring entity, especially when the terminal is offline, i.e., there is no communication link to the monitoring entity.

The terminal may have a security element in which the electronic coin data sets are stored securely. A security element is preferably a special computer program product, in particular in the form of a secure runtime environment within an operating system of a terminal, in English Trusted Execution Environments, TEE, stored on a data storage device, for example a mobile terminal, a machine, preferably an ATM. Alternatively, the security element is designed, for example, as special hardware, in particular in the form of a secured hardware platform module, in English Trusted Platform Module, TPM, or as an embedded security module, eUICC, eSIM. The security element provides a trusted environment.

The communication between two terminals can be wireless or wired, or e.g. also via optical path, preferably via QR code or barcode, and can be designed as a secured channel. The optical path may comprise, for example, the steps of generating an optical code, in particular a 2D code, preferably a QR code, and reading the optical code. Thus, the exchange of the electronic coin data set is secured, for example, by cryptographic keys, such as a session key negotiated for an electronic coin data set exchange or a symmetric or asymmetric key pair.

By communicating between terminals, for example via their security elements, the exchanged electronic coin data sets are protected from theft or tampering. The security element layer thus complements the security of established blockchain technology.

In a preferred embodiment, the transfer of the coin data sets takes place as APDU commands. For this purpose, the coin data set is preferably stored in an (embedded) UICC as a security element and is managed there. An APDU is a combined command/data block of a connection protocol between the UICC and a device. The structure of the APDU is defined by the ISO-7816-4 standard. APDUs represent an information element of the application layer (layer 7 of the OSI layer model).

In addition, it is advantageous that the electronic coin data sets can be transferred in any format. This implies that they can be communicated in arbitrary channels, i.e. they can be transferred. They do not have to be stored in a fixed format or in a specific program.

In particular, a mobile telecommunications terminal, for example a smartphone, is regarded as a terminal. Alternatively or additionally, the terminal can also be a device, such as a wearable, smart card, machine, tool, vending machine or even container or vehicle. A terminal according to the invention is thus either stationary or mobile. The terminal is preferably designed to use the Internet and/or other public or private networks. For this purpose, the terminal uses a suitable connection technology, for example Bluetooth, Lora, NFC and/or WiFi, and has at least one corresponding interface. The terminal may also be designed to be combined with the Internet and/or other networks by means of access to a mobile network.

In one embodiment, it can be provided that the first and/or second terminal processes the received electronic coin data sets according to their monetary value when several electronic coin data sets are present or received in the method shown. Thus, it can be provided that electronic coin data sets with higher monetary value are processed before electronic coin data sets with lower monetary value. In one embodiment, the first and/or second terminal may be designed, after receiving an electronic coin data set, to combine it with an electronic coin data set already present in the second terminal depending on attached information, for example, a currency or denomination, and to perform a step of combining accordingly. Furthermore, the second terminal may also be configured to perform an automated switching after receiving the electronic coin data set from the first terminal.

In one embodiment, further information, in particular metadata, is transferred from the first terminal to the second terminal during the transfer, for example a currency. In one embodiment, this information may be comprised by the electronic coin data set.

In a preferred embodiment, the method has the following further steps: Masking the transferred electronic coin data set in the second terminal by applying, for example, the homomorphic one-way function to the transferred electronic coin data set; and transmitting the masked transferred electronic coin data set to the remote monitoring entity for checking the validity of the transferred electronic coin data set by the remote monitoring entity. For example, in this case, the entire monetary amount within the electronic coin data set was transferred to the second terminal. Before a payee accepts this electronic coin data set, it verifies its validity, if applicable. To this end, the second terminal generates the masked transferred electronic coin data set, transmits it to the monitoring entity, and in the process queries the monitoring entity about the validity of the electronic coin data set. The monitoring entity now checks whether the masked transferred electronic coin data set exists at all and whether it is still valid, i.e. has not already been consumed by another terminal, in order to avoid double spending.

In one embodiment, a proof is generated in the second terminal. The proof comprises information about the correspondence between the monetary amount of the transferred electronic coin data set and the monetary amount of the electronic coin data set to be switched. Preferably, the verification comprises only information about the match, but not one of the monetary amounts.

Preferably, during the registering step, verification of the electronic coin data set of the first and/or second terminal is performed in or by the monitoring entity. The verification is performed depending on the steps preceding the verification, for example whether a step of switching, combining and/or splitting has taken place. In doing so, the monitoring entity can, for example, check the validity of the (masked) transferred and/or split and/or first and second electronic coin data sets. This makes it possible to determine whether the electronic coin data sets are being processed for the first time. If the (masked) electronic coin data sets are not valid (i.e. in particular if they are not present in the monitoring entity), the registration cannot be successfully performed, for example because the terminal tries to output an electronic coin data set multiple times.

In a further preferred embodiment, after executing the switching step, the registering step comprises, for example, sending the switching command prepared by the terminal to the monitoring entity. Preferably, the monitoring entity communicates the result of executing the switching command to the “commanding” terminal, i.e., which of the involved masked electronic coin data sets are valid after executing the switching command.

In a preferred embodiment, the monitoring entity is a remote entity. Thus, for example, establishing a communication link to the monitoring entity is provided for registering the electronic coin data set.

The monitoring entity is designed as a higher-level entity. Accordingly, the monitoring entity is not necessarily arranged in the level or layer of the terminals (direct transaction layer). Preferably, the monitoring entity is provided for the administration and verification of masked electronic coin data sets and is arranged in an issuing layer, in which an issuing entity is also arranged, and/or in a monitoring layer. It is conceivable that the monitoring entity additionally manages and checks transactions between terminals.

The monitoring entity is preferably a decentrally controlled database, Distributed Ledger Technology, DLT, in which the masked electronic coin data sets are registered with corresponding processing of the masked electronic coin data set. In a preferred embodiment, a validity status of the (masked) electronic coin data set can be derived therefrom. Preferably, the validity of the (masked) electronic coin data set is noted in and by the monitoring entity. The registration of the processing or processing steps may also concern the registration of verification results and intermediate verification results concerning the validity of an electronic coin data set. If a processing is final, this is indicated, for example, by corresponding markings or a derived overall marking. Final processing then determines whether an electronic coin data set is valid or invalid.

This database is further preferably a non-public database, but can also be implemented as a public database. This database makes it easy to check coin data sets for validity and to prevent double spending without registering or logging the payment transaction itself. The DLT describes a technique for networked computers to agree on the order of certain transactions and that these transactions update data. It corresponds to a decentralised management system or database.

In a further embodiment, the database may be a public database.

Alternatively, the monitoring entity is a centrally managed database, for example in the form of a publicly accessible data repository or as a hybrid of a centralized and decentralized database.

Preferably, the at least one initial electronic coin data set is created exclusively by the issuing entity, although preferably the split electronic coin data sets, in particular electronic coin partial data sets, can also be generated by a terminal. Preferably, creating and selecting a monetary amount also includes selecting a high entropy obfuscation amount. The issuing entity is a computing system, which is preferably remote from the first and/or second terminal. After the new electronic coin data set is created, the new electronic coin data set is masked in the issuing entity by applying the, for example, homomorphic one-way function to the new electronic coin data set to obtain a masked new electronic coin data set accordingly. Furthermore, additional information needed to register the creation of the masked new electronic coin data set in the remote monitoring entity is calculated in the issuing entity. Preferably, this further information is a proof that the (masked) new electronic coin data set originates from the issuing entity, for example by signing the masked new electronic coin data set. In one embodiment, the issuing entity may sign a masked electronic coin data set with its signature when generating the electronic coin data set. The signature of the issuing entity is stored in the monitoring entity for this purpose. The signature of the issuing entity is different from the generated signature of the first terminal.

Preferably, the issuing entity can deactivate an electronic coin data set in its possession (i.e., of which it knows the monetary amount and the obfuscation amount) by masking the masked electronic coin data set to be deactivated with, for example, the homomorphic one-way function and preparing a deactivate command for the monitoring entity. Part of the deactivate command is preferably, besides the masked electronic coin data set to be deactivated, also the evidence that the deactivate step was initiated by the issuing entity, for example in the form of the signed masked electronic coin data set to be deactivated. As additional information, range checks for the masked electronic coin data set to be deactivated could be included in the deactivate command. This is followed by registering the deactivation of the masked electronic coin data set in the remote monitoring entity. The deactivate command triggers the deactivate step.

Preferably, the create and deactivate steps occur in secured locations, particularly not in the terminals. In a preferred embodiment, the create and deactivate steps are performed or triggered only by the issuing entity. Preferably, these steps take place in a secure location, for example in a hardware and software architecture designed to process sensitive data material in insecure networks. Deactivating the corresponding masked electronic coin data set has the effect that the corresponding masked electronic coin data set is no longer available for further processing, in particular transactions, as it has been marked as invalid in and by the monitoring entity. However, in one embodiment, it may be provided that the deactivated masked electronic coin data set remains in archival form at the issuing entity. The fact that the deactivated masked electronic coin data set is no longer valid may be indicated, for example, by means of a flag or other coding, or the deactivated masked electronic coin data set may be destroyed and/or deleted. Of course, the deactivated masked electronic coin data set can also be physically removed from the terminal.

The method according to the invention enables various processing operations for the electronic coin data sets and the corresponding masked electronic coin data sets. Each of the processing operations (in particular, creating, deactivating, splitting, combining and switching) is thereby registered in the monitoring entity and appended there in unchanged form to the list of previous processing operations for the respective masked electronic coin data set. The registration is independent of the payment process between the terminals in terms of both time and location (space). The processing operations “create” and “deactivate”, which concern the existence of the monetary amount per se, i.e. the creation and destruction up to the destruction of money, require an additional approval, for example in the form of a signature, by the issuing entity in order to be registered (i.e. logged) in the monitoring entity. The remaining processing operations (splitting, combining, switching) do not require authorization by the issuing entity or by the command initiator (= payer, e.g. the first terminal).

Processing in the direct transaction layer only concerns the ownership and/or allocation of the coin data sets to terminals of the respective electronic coin data sets. A registration of the respective processing in the monitoring entity is realized, for example, by corresponding list entries in a database, which comprises a number of markings to be performed by the monitoring entity. For example, a possible structure for a list entry comprises column(s) for a predecessor coin data set, column(s) for a successor coin data set, a signature column for the issuing entity, a signature column for coin split operations, and at least one marking column. A change in the status of the marker requires approval by the monitoring entity and must then be stored in an unalterable form. A change is final if and only if the required markers have been validated by the monitoring entity, i.e. changed from status “0” to status “1” after the corresponding check, for example. If a check fails or takes too long, it is changed from status “-” to status “0” instead, for example. Other status values are conceivable and/or the status values mentioned here are interchangeable. Preferably, the validity of the respective (masked) electronic coin data sets is shown summarized from the status values of the markers, each in a column for each masked electronic coin data set involved in registering the processing.

In a further embodiment, at least two preferably three or even all of the aforementioned markers may also be replaced by a single marker that is set when all checks have been successfully completed. Furthermore, the two columns for predecessor data sets and successor data sets can be combined into one column each, in which all coin data sets are listed together. This would make it possible to manage more than two electronic coin data sets per field entry and thus, for example, to split the data into more than two coins.

The checks by the monitoring entity to check whether a processing is final are already described above and are in particular:
Are the masked electronic coin data sets of the predecessor column(s) valid?
Does monitoring yield the correct check value?
Are the range verifications for the masked electronic coin data sets successful?
Is the signature of the masked electronic coin data set a valid signature of the issuing entity?

Preferably, a masked electronic coin data set is also invalid if any of the following checks apply, i.e., if:
(1) the masked electronic coin data set is not registered in the monitoring entity;
(2) the last processing of the masked electronic coin data set indicates that there are predecessor coin data sets for it, but that last processing is not final; or
(3) the last processing of the masked electronic coin data set indicates that there are successor coin data sets for it and that last processing is final;
(4) the masked electronic coin data set is not the successor to a valid masked electronic data set unless it is signed by the issuing entity.

In one aspect of the invention, a payment system for exchanging monetary amounts is provided with a monitoring layer comprising a preferably decentrally controlled database, Distributed Ledger Technology, DLT, in which masked electronic coin data sets are stored; and a direct transaction layer comprising at least two terminals in which the method described above can be performed; and/or an issuing entity for generating an electronic coin data set. In this regard, the issuing entity can prove that the masked generated electronic coin data set was generated by it, preferably the issuing entity can identify itself by signing and the monitoring entity can check the signature of the issuing entity.

In a preferred embodiment, the payment system comprises an issuing entity for generating an electronic coin data set. In doing so, the issuing entity can prove that the masked generated electronic coin data set was generated by the issuing entity, preferably the issuing entity can identify itself by signing and the monitoring entity can check the signature of the issuing entity.

Preferably, the payment system is adapted to perform the above method and/or at least one of the embodiments.

Another aspect of the invention relates to a currency system comprising an issuing entity, a monitoring entity, a first terminal and a second terminal, wherein the issuing entity is adapted to create an electronic coin data set. The masked electronic coin data set is adapted to be detectably created by the issuing entity. The monitoring entity is adapted to perform a registration step as set forth in the above method Preferably, the terminals, i.e., at least the first and second terminals are adapted to perform one of the above methods for transferring.

In a preferred embodiment of the currency system, only the issuing entity is authorized to initially create an electronic coin data set. Processing, for example the step of combining, splitting and/or switching, can be and preferably is performed by a terminal. The processing step of deactivating can preferably only be performed by the issuing entity. Thus, only the issuing entity would be authorized to invalidate the electronic coin data set and/or the masked electronic coin data set.

Preferably, the monitoring entity and the issuing entity are arranged in a server entity or are present as a computer program product on a server and/or a computer.

An electronic coin data set can exist in a variety of different manifestations and thus be exchanged via different communication channels, hereinafter also referred to as interfaces. A very flexible exchange of electronic coin data sets is thus created.

The electronic coin data set can be represented, for example, in the form of a file. A file consists of related data stored on a data carrier, data memory or storage medium. Each file is initially a onedimensional string of bits, which are normally interpreted as a group of byte blocks. An application program (application) or an operating system itself interprets this bit or byte sequence as, for example, a text, an image or a sound recording. The file format used in this process can vary, for example it can be a plain text file representing the electronic coin data set. In particular, the monetary amount and the blind signature are represented as a file.

For example, the electronic coin data set is a sequence of American Standard Code for Information Interchange, or ASCII, characters. In particular, the monetary amount and the blind signature are mapped as this sequence.

The electronic coin data set can also be converted from one form of representation to another form of representation in a device. For example, the electronic coin data set can be received as a QR code in the device and output as a file or string from the device.

These different representation forms of one and the same electronic coin data set allow a very flexible exchange between devices of different technical equipment using different transmission media (air, paper, wired) and taking into account the technical design of a device. The choice of the presentation form of the electronic coin data sets is preferably made automatically, for example, based on recognized or negotiated transmission media and device components. Additionally, a user of a device may also select the representation form for exchanging (=transferring) an electronic coin data set.

In one aspect of the invention, the problem is solved by a device arranged for direct transfer of electronic coin data sets to another device. The apparatus comprises means for accessing a data memory, the data memory having at least one electronic coin data set stored therein; an interface for at least outputting the at least one electronic coin data set to the other apparatus; and a computing unit arranged for masking the electronic coin data set in the device by applying the, for example, homomorphic (encryption) one-way function to the electronic coin data set for obtaining a masked electronic coin data set for registering the masked electronic coin data set in a monitoring entity; and for outputting the electronic coin data set by means of the interface.

In this regard, a device is a previously described terminal or machine.

In one simple case, the data store is an internal data store of the device. This is where the electronic coin data sets are stored. Easy access to electronic coin data sets is thus ensured.

In particular, the data memory is an external data memory, also called online memory. Thus, the device has only one means of accessing the coin data sets stored externally and thus securely. In particular, if the device is lost or malfunctions, the electronic coin data sets are not lost. Since possession of the (unmasked) electronic coin data sets equals possession of the monetary amount, money can be stored more securely by using external data storage.

If the monitoring entity is a remote monitoring entity, the device preferably interfaces for communication using a common internet communication protocol, such as TCP, IP, UDP, or HTTP. The transfer may include communication over the cellular network.

In a preferred embodiment, the device is arranged to perform the processing operations already described, in particular split, combine and switch, on an electronic coin data set. For this purpose, the computing unit is arranged to mask an electronic coin data set to be switched as the electronic coin data set that the monitoring entity needs as the masked electronic coin data set for registering the switching command or in the switching step. In this way, an electronic coin data set – as described above – can be switched.

Moreover, or alternatively, the computing unit is preferably arranged to mask an electronic coin partial data set split into a number of coin partial data sets to obtain a masked electronic coin data set and, if necessary, masked electronic coin partial data sets that can be registered in the monitoring entity. In this way, an electronic coin data set can be split – as described above.

Furthermore or alternatively, the computing entity is preferably arranged to mask an electronic coin partial data set to be combined from a first and a second electronic coin data set as the electronic coin data set to obtain a masked coin partial data set to be combined as the masked electronic coin data set to be registered in the monitoring entity. In this way, an electronic coin data set – as described above – can be combined.

In a preferred embodiment, the interface for outputting the at least one electronic coin data set is an electronic display unit of the device, which is arranged for displaying the electronic coin data set and thereby (also) for outputting the electronic coin data set in visual form. As has already been described, the electronic coin data set is then interchangeable between devices, for example in the form of an optoelectronically detectable code, an image, etc.

In a preferred embodiment, the interface for outputting the at least one electronic coin data set is a protocol interface for wirelessly transmitting the electronic coin data set to the other device using a wireless communication protocol. In particular, near field communication, for example by means of Bluetooth protocol or NFC protocol or IR protocol is provided, alternatively or additionally WLANconnections or mobile radio connections are conceivable. The electronic coin data set is then adapted and transferred according to the protocol properties.

In a preferred embodiment, the interface for outputting the at least one electronic coin data set is a data interface for providing the electronic coin data set to the other device by means of an application. In contrast to the protocol interface, the electronic coin data set is transferred by means of an application. This application then transfers the coin data set in an appropriate file format. A file format specific to electronic coin data sets can be used. In its simplest form, the coin data set is transferred as an ASCII string or text message, for example, SMS, MMS, instant messenger message (such as Threema or WhatsApp). In an alternative form, the coin data set is transferred as an APDU string. A wallet application may also be provided. In this case, the exchanging devices preferably ensure that an exchange is possible using the application, i.e., that both devices have the application and are ready to exchange.

In a preferred embodiment, the device further has an interface for receiving electronic coin data sets.

In a preferred embodiment, the interface for receiving the at least one electronic coin data set is an electronic capture module of the device, arranged for capturing an electronic coin data set presented in visual form. The capture module is then, for example, a camera or a barcode or QR code scanner.

In a preferred embodiment, the interface for receiving the at least one electronic coin data set is a protocol interface for wirelessly receiving the electronic coin data set from another device using a communication protocol for wireless communication. In particular, near-field communication, for example by means of Bluetooth protocol or NFC protocol or IR protocol, is provided. Alternatively or additionally, WLAN connections or mobile radio connections are conceivable.

In a preferred embodiment, the interface for receiving the at least one electronic coin data set is a data interface for receiving the electronic coin data set from the other device by means of an application. This application then receives the coin data set in a corresponding file format. A file format specific to coin data sets may be used. In its simplest form, the coin data set is transferred as an ASCII string or as a text message, for example SMS, MMS, Threema or WhatsApp. In an alternative form, the coin data set is transferred as an APDU string. Additionally, the transfer may be performed using a wallet application.

In a preferred embodiment, the interface for receiving the at least one electronic coin data set is also the interface for outputting the electronic coin data set, such that an interface is provided for both transmitting and receiving the coin data set.

In a preferred embodiment, the device comprises at least one security element reader arranged to read a security element; a random number generator; and/or a communication interface to a vault module and/or banking institution with access to a bank account to be authorized.

In a preferred embodiment, the data store is a shared data store accessible by at least one other terminal, each of the terminals having an application, said application being arranged to communicate with the monitoring entity for registering electronic coin partial data sets accordingly.

Thus, what is proposed here is a solution that issues digital money in the form of electronic coin data sets, which is modelled on the use of conventional (analogue) banknotes and/or coins. The digital money is represented here by electronic coin data sets. As with (analogue) banknotes, these electronic coin data sets become usable for all forms of payments, including peer-to-peer payments and/or POS payments. Knowing all the components (especially monetary amount and obfuscation amount) of a valid electronic coin data set is equivalent to possession (ownership) of the digital money. It is therefore advisable to keep these valid electronic coin data sets confidential, e.g., to store them in a security element/vault module of a terminal and process them there. In order to decide on the authenticity of an electronic coin data set and to prevent duplicate issues, masked electronic coin data sets are kept in the monitoring entity as a unique corresponding public representation of the electronic coin data set. Knowledge or possession of a masked electronic coin data set does not constitute possession of money. Rather, it is akin to verifying the authenticity of the analogue currency.

The monitoring entity also includes markers about performed and planned processings of the masked electronic coin data set. A status of the respective masked electronic coin data set is derived from the markers about the processings, indicating whether the corresponding (unmasked) electronic coin data set is valid, i.e. ready for payment. Therefore, a recipient of an electronic coin data set will first generate a masked electronic coin data set and have the monitoring entity authenticate the validity of the masked electronic coin data set. A major advantage of this solution according to the invention is that the digital money is distributed to terminals, merchants, banks and other users of the system, but no digital money or other metadata is stored at the monitoring entity – i.e. a common entity.

The proposed solution can be integrated with existing payment systems and infrastructures. In particular, there can be a combination of analogue payment transactions with banknotes and coins and digital payment transactions according to the present solution. For example, a payment transaction can be made with banknotes and/or coins, but the change or change back is available as an electronic coin data set. For the transaction, for example, ATMs with a corresponding configuration, in particular with a suitable communication interface, and/or mobile terminals can be provided. It is also conceivable to exchange electronic coin data sets for banknotes or coins.

The steps of creating, switching, splitting, combining and deactivating listed above are each triggered by a corresponding create, switch, split, combine or deactivate command.

The problem is further solved by a monitoring unit arranged to receive a masked electronic coin data set and to register the masked electronic coin data set. The masked electronic coin data set is masked in a first masking mode or a second masking mode or a third masking mode or a fourth masking mode. Preferably, the masked electronic coin data set is masked according to a masking step from the method described above. The monitoring unit is further adapted to register a modification of a coin data set according to the method previously described.

### BRIEF SUMMARY OF THE FIGURES

In the following, the invention or further embodiments and advantages of the invention will be explained in more detail with reference to figures, the figures merely describing embodiments of the invention. Identical components in the figures are given the same reference signs. The figures are not to be regarded as true to scale, and individual elements of the figures may be shown in exaggeratedly large or exaggeratedly simplified form.

They show:

FIG. 1 an embodiment example of a payment system according to the invention;

FIG. 2 an embodiment example of a monitoring entity;

FIG. 3 an embodiment example of a payment system according to the invention for splitting and switching electronic coin data sets;

FIG. 4 an embodiment example of a payment system according to the invention for combining electronic coin data sets;

FIG. 5 an embodiment example of a method flow chart of a method according to the invention and corresponding processing steps of a coin data set;

FIG. 6 an embodiment of a method flow chart of a method according to the invention and corresponding processing steps of a coin data set;

FIG. 7 a further embodiment example of a method flow chart of a method according to the invention;

FIG. 8 an embodiment example of an apparatus according to the invention;

FIG. 9 another embodiment example of a process flow diagram of a method according to the invention according to a second masking mode;

FIG. 10 a schematic representation of the method according to FIG. 9;

FIG. 11 a further embodiment example of a process flow diagram of a method according to the invention;

FIG. 12 a further embodiment of a method according to the invention; and

FIG. 13 a process flow diagram of the method according to the invention shown in FIG. 12.

### FIGURE DESCRIPTION

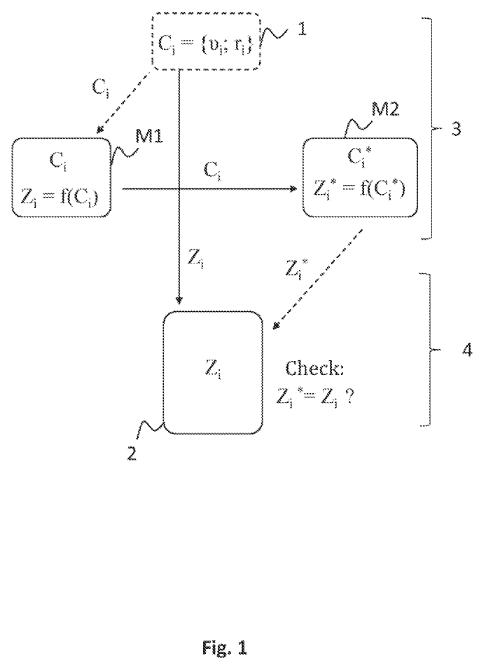

FIG. 1 shows an embodiment example of a payment system with terminals M1 and M2 according to the invention. The terminals M1 and M2 may be devices.

In this case, an electronic coin data set Cᵢ is generated in an issuing entity 1, for example a central bank. A masked electronic coin data set Zᵢ is generated for the electronic coin data set Cᵢ and registered in an “obfuscated electronic coin data set ledger”. In the context of the present invention, a ledger is understood to be a list, a directory, preferably a database structure. The electronic coin data set Cᵢ is output to a first terminal M1.

For example, a true random number has been generated as obfuscation amount rᵢ for this purpose. This obfuscation amount rᵢ is linked to a monetary amount νᵢ and then forms an i-th electronic coin data set according to the invention:

$${C}_{i} = \left\{{υ}_{i} ; {r}_{i}\right\}$$

A valid electronic coin data set can be used for payment. The owner of the two values νᵢ and rᵢ is therefore in possession of the digital money. However, the digital money is defined by a pair consisting of a valid electronic coin data set and a corresponding masked electronic coin data set Zᵢ. The masked electronic coin data set Z; is obtained by applying a one-way function f(Cᵢ) according to equation (2):

$${Z}_{i} = f \left({C}_{i}\right)$$

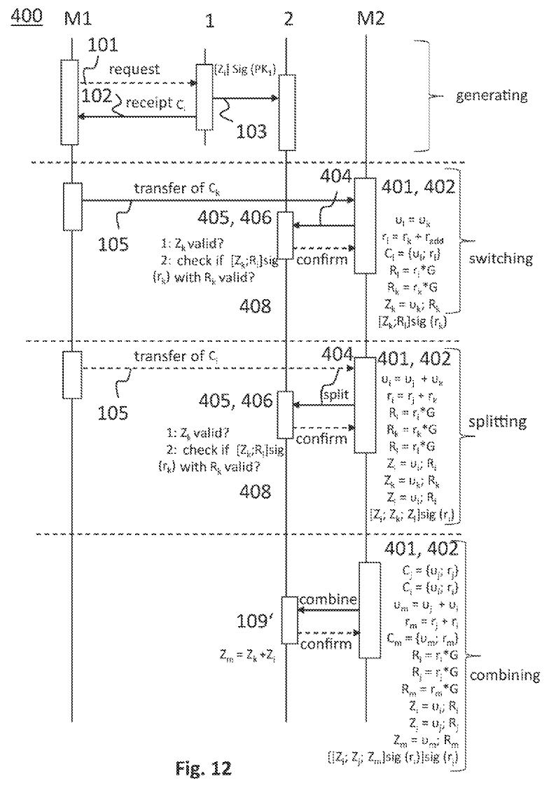

For example, the one-way function f(Cᵢ) is homomorphic. The masked electronic coin data set is, for example, a fully electronic masked coin data set, an incompletely masked electronic coin data set, a quasi-masked electronic coin data set or a partially masked electronic coin data set, as will be further detailed with reference to FIG. 12 and following.

In particular, this function f (Cᵢ) is public for a fully masked electronic coin data set an incompletely masked electronic coin data set and a partially masked electronic coin data set, i.e., any system participant in the payment system can invoke and use this function. This function f (Ci) is defined according to equation (3) or equation (3a), for example:

$${Z}_{i} = {υ}_{i} ⋅ H + {r}_{i} ⋅ G$$

$${Z}_{i} = {r}_{i} ⋅ G$$

where H and G are generator points of a group in which the discrete logarithm problem is hard, with the generators G and H for which the discrete logarithm of the other basis is unknown. For example, G (equation (3), (3a)) as well as H (equation (3)) are each a generator point of an elliptic curve encryption, ECC, – that is, private keys of the ECC. In the case of equation (3), these generator points G and H must be chosen in such a way that the context of G and H is not publicly known, so that if:

$$G = n ⋅ H$$

the concatenation n must be practically undetectable to prevent the monetary amount νᵢ from being manipulated and a valid Zᵢ could still be calculated. Equation (3) is a “Pederson commitment for ECC” that ensures that the monetary amount νᵢ can be conceded, i.e., “committed,” to a monitoring entity 2 without revealing it to the monitoring entity 2. Therefore, only the masked coin data set Zᵢ is sent (disclosed) to the public and remote monitoring entity 2.

Even though in the present example an encryption based on elliptic curves is or will be described, another cryptographic method would also be conceivable, which is based on a discrete logarithmic method and is based on equation (3a).

When equation (3a) is applied, a one-way function is only applied to a part of the coin data set C, in this case the obfuscation amount r, this partially masked coin data set can also be referred to as R.

Equation (3), through the entropy of the obfuscation amount rᵢ, allows a cryptographically strong Zᵢ to be obtained even when the range of values for monetary amounts νᵢ is small. Thus, a simple brute-force attack by merely estimating monetary amounts νᵢ is practically impossible.

Equations (3) and (3a) use one-way functions, meaning that calculating Zᵢ from Cᵢ is easy because an efficient algorithm exists, whereas calculating Cᵢ starting from Zᵢ is very hard because no algorithm that can be solved in polynomial time exists.

Moreover, equation (3) is homomorphic for addition and subtraction, that is:

$${Z}_{i} + {Z}_{j} = \left({υ}_{i} ⋅ H + {r}_{i} ⋅ G\right) + \left({υ}_{j} ⋅ H + {r}_{j} ⋅ G\right) = \left({υ}_{i} + {υ}_{j}\right) ⋅ H + \left({r}_{i} + {r}_{j}\right) ⋅ G$$

Thus, addition operations and subtraction operations can be performed both in the direct transaction layer 3 and in parallel in the monitoring layer 4 without the monitoring layer 4 having knowledge of the electronic coin data sets Cᵢ. The homomorphic property of equation (3) allows monitoring of valid and invalid electronic coin data sets Cᵢ to be conducted based solely on the masked coin data sets Z; and to ensure that no new monetary amount νⱼ has been created.

This homomorphic property allows the coin data set Cᵢ to be split according to equation (1) into:

$${C}_{i} = {C}_{j} + {C}_{k} = \left\{{υ}_{j} ; {r}_{j}\right\} + \left\{{υ}_{k} ; {r}_{k}\right\}$$

where holds:

$${υ}_{i} = {υ}_{j} + {υ}_{k}$$

$${r}_{i} = {r}_{j} + {r}_{k}$$

For the corresponding masked coin data sets:

$${Z}_{i} = {Z}_{j} + {Z}_{k}$$

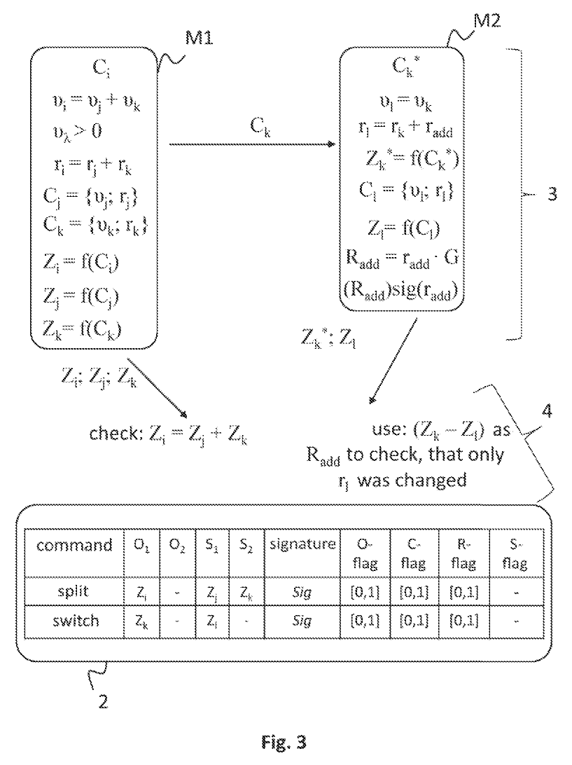

Equation (9), for example, can be used to easily check a “split” processing or a “split” processing step of a coin data set according to FIG. 3 without the monitoring entity 2 having knowledge of Cᵢ, Cⱼ, Cₖ. In particular, the condition of equation (9) is checked to declare split coin data sets Cⱼ and Cₖ valid and coin data set Cₖ invalid. Such a split of an electronic coin data set Cᵢ is shown in FIG. 3.

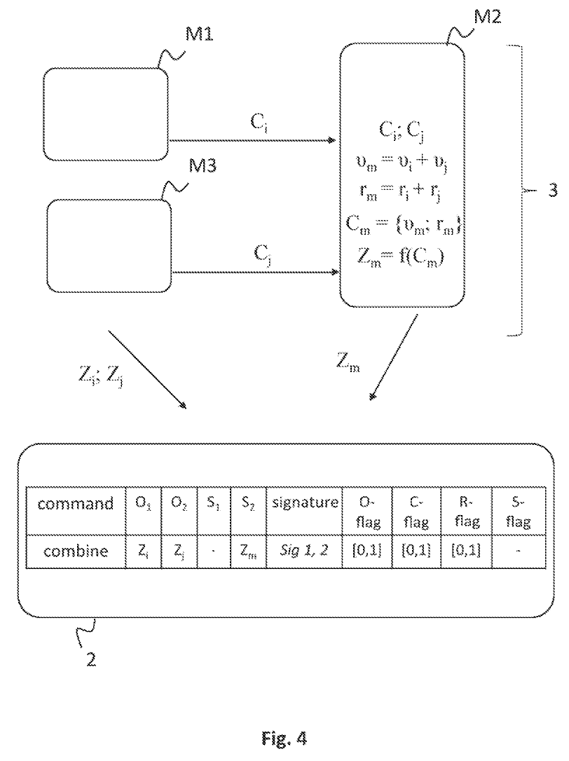

In the same way, electronic coin data sets can also be combined (joined), see FIG. 4 and the explanations thereto.

Additionally, it is important to check whether (not allowed) negative monetary amounts are registered. An owner of an electronic coin data set Cᵢ must be able to prove to the monitoring entity 2 that all monetary amounts νᵢ in a processing operation are within a value range of [0, ..., 2ⁿ-1] without informing the monitoring entity 2 of the monetary amounts νᵢ. These range verifications are also called “range proofs”. Preferably, ring signatures (Engl. ring signatures) are used as range verifications. For the present embodiment example, both the monetary amount ν and the obfuscation amount r of an electronic coin data set C are resolved in bit representation. It holds:

$${υ}_{i} \sum {\text{a}}_{\text{j}} ⋅ {2}^{\text{j}} \text{for} \text{0} \leq \text{j} < \text{n} \text{and} {\text{a}}_{\text{j}} „ \text{element} “ \left\{0 ; 1\right\}$$

as well as

$${\text{r}}_{\text{i}} = \sum {\text{b}}_{\text{j}} ⋅ {2}^{\text{j}} \text{for} 0 \leq j < \text{n} \text{and} {\text{b}}_{\text{j}} „ \text{element} “ \left\{0 : 1\right\}$$

For each bit, a ring signature is preferably generated with

$${\text{C}}_{\text{ij}} {\text{=a}}_{\text{j}} ⋅ {\text{H+b}}_{\text{j}} ⋅ G$$

and

$${\text{C}}_{\text{ij}} {\text{-a}}_{\text{j}} ⋅ \text{H}$$

whereby, in one embodiment, provision can be made to perform a ring signature only for certain bits.

In FIG. 1, an electronic coin data set Cᵢ is generated by the issuing entity 1 and a masked electronic coin data set Zᵢ is calculated by the issuing entity 1 using equation (3) or equation (3a) and this is registered in the monitoring entity 2.

Subsequently, the first terminal M1, which can transfer the electronic coin data set Cᵢ to a second terminal M2 or perform one of the processing steps (switching, combining, splitting), transfers. The transfer is performed, for example, wirelessly via WLAN, NFC or Bluetooth. The transfer may be further secured by cryptographic encryption methods, for example by negotiating a session key or applying a PKI infrastructure.

In the second terminal M2, the transferred electronic coin data set Cᵢ is obtained as Cᵢ^{∗}. Upon obtaining the electronic coin data set Cᵢ^{∗}, the second terminal M2 is in possession of the digital money represented by the electronic coin data set Cᵢ^{∗}. If both terminals trust each other, no further steps are required to complete the method. However, the terminal M2 does not know whether the electronic coin data set Cᵢ^{∗} is actually valid. Moreover, the terminal M1 could still transfer the electronic coin data set Cᵢ to a third terminal (not shown). To prevent this, further preferred steps in the method are provided.

To check the validity of the obtained electronic coin data set Cᵢ^{∗}, the masked transferred electronic coin data set Zᵢ^{∗} is calculated in the second terminal M2 using the – public – one-way function from equation (3) or the equation (3a). The masked transferred electronic coin data set Zᵢ^{∗} is then transferred to the monitoring entity 2 and searched there. If it matches a registered and valid masked electronic coin data set, the validity of the obtained coin data set Cᵢ^{∗} is indicated to the second terminal M2 and it is valid that the obtained electronic coin data set Cᵢ^{∗} is equal to the registered electronic coin data set Cᵢ^{∗}. In one embodiment, the validity check can be used to determine that the obtained electronic coin data set Cᵢ^{∗} is still valid, i.e. that it has not already been used by another processing step or in another transaction and/or has not been subject to further modification.

Preferably, a switching of the obtained electronic coin data set takes place thereafter.

It is valid for the method according to the invention that the sole knowledge of a masked electronic coin data Zᵢ set does not entitle to spend the digital money. However, the sole knowledge of the electronic coin data set Cᵢ entitles to pay, i.e. to perform a transaction successfully, especially if the coin data set Cᵢ is valid. There is a one-to-one relationship between the electronic coin data sets Cᵢ and the corresponding masked electronic coin data sets Zᵢ. The masked electronic coin data sets are registered in the monitoring entity 2, for example a public decentralized database. This registration first makes it possible to check the validity of the electronic coin data set, for example whether new monetary amounts have been created (illegally).

A main distinguishing feature compared to conventional solutions is that the masked electronic coin data sets Zᵢ are stored in a monitoring layer 4 and all processing on the electronic coin data set Zᵢ is registered there, whereas the actual transfer of the digital money takes place in a (secret, i.e. not known to the public) direct transaction layer 3.

To prevent multiple issuance or to ensure more flexible transfer, the electronic coin data sets can now be processed in the method according to the invention. Table 1 below lists the individual operations, with the specified command also executing a corresponding processing step:

TABLE 1

number of operations that can be performed per processing of a coin data set in the terminal or Issuing entity can be performed;

| command or step | create signature | create random number | create masking | create range verification |
|---|---|---|---|---|
| generate | 1 | 1 | 1 | 0 or 1 |
| deactivate | 1 | 0 | 1 | 0 or 1 |
| split | 0 | 1 | 3 | 0 or 1 |
| combine | 0 | 0 | 3 | 1 |
| switch | 0 | 1 | 2 | 1 |

Other operations not listed in table 1 may be required. Instead of the listed implementation, other implementations are also conceivable that imply other operations. Table 1 shows that for each coin data set, each of the processing operations “create”, “deactivate”, “split”, “combine” and “switch” may provide different operations “create signature”; “create random number”; “create masking”; “range check”, each of the processing operation being registered in the monitoring entity 2 and appended there in invariant form to a list of previous processing operations for masked electronic coin data sets Zᵢ. The operations of the processing operations “creating” and “deactivating” an electronic coin data set are performed only at secure locations and/or only by selected entities, for example, issuing entity 1, while the operations of all other processing operations can be performed on terminals M1 to M3.

The number of operations for each processing is indicated by “0”, “1” or “2” in table 1. The number “0” indicates that the terminal or issuing entity 1 does not have to perform this operation for this processing of the electronic coin data set. The number “1” indicates that the terminal or issuing entity 1 must be able to perform this operation once for this processing of the electronic coin data set. The number “2” indicates that the terminal or issuing entity 1 must be able to perform this operation twice for this processing of the electronic coin data set.

In principle, in one embodiment, it can also be provided that an area check is also performed by the issuing entity 1 when generating and/or deleting.

Table 2 below lists the operations required for the monitoring entity 2 for the individual processing operations:

TABLE 2

number of operations that can be performed per processing of a coin data set in the monitoring entity;

| command or step | check signature from issuer | check validity of masked electronic coin data set | trace range verification | trace homomorphic properties of masked electronic coin data sets, i.e., add or subtract |
|---|---|---|---|---|
| generate | 1 | 0 | 0 or 1 | 0 |
| deactivate | 1 | 1 | 0 or 1 | 0 |
| split | 0 | 1 | 2 or more | 1 |
| combine | 0 | 2 or more | 1 | 1 |
| switch | 0 | 1 | 1 | 0 |

Other operations not listed in table 2 may be required. Instead of the listed implementation, other implementations are conceivable that imply other operations. All operations of table 2 can be performed in the monitoring entity 2, which is a trusted entity, for example a decentralized server, in particular a distributed trusted server, that ensures sufficient integrity of the electronic coin data sets.

Table 3 shows the preferred components to be installed for the system participants in the payment system of FIG. 1:

TABLE 3

preferred units in system components.

| | | | |
|---|---|---|---|
| command or step | issuing entity | terminal | monitoring entity |
| random generator (high security) | Yes | - | - |
| random generator (deterministic) | - | Yes | - |
| PKI for signing | Yes | - | - |
| PIK for signature verification | - | (Yes) | Yes |
| read access to DLT | Yes | Yes | Yes |
| write access to DLT | Yes | Yes | Yes |
| deactivation of electronic coin data set | Yes | Yes | - |
| transport encryption | Yes | Yes | - |
| secure storage | (Yes) | Yes | -/Yes |
| masking unit | Yes | Yes | - |
| range verification | - | Yes | - |
| check range verification | - | - | Yes |
| DLT software | - | - | Yes |

Table 3 shows an overview of the preferred components to be used in each system participant, i.e. the issuing entity 1, a terminal M1 and the monitoring entity 2. The terminal M1 can be used as a wallet for electronic coin data sets Cᵢ, i.e. as an electronic wallet, i.e. a data memory of the terminal M1 in which a plurality of coin data sets Cᵢ may be stored, and may be implemented, for example, in the form of an application on a smartphone or IT system of a merchant, a commercial bank or another market participant and transmit or receive an electronic coin data set. Thus, the components are implemented as software in the terminal as shown in Table 3. It is assumed that the monitoring entity 2 is based on a DLT and operated by a number of trusted market participants.

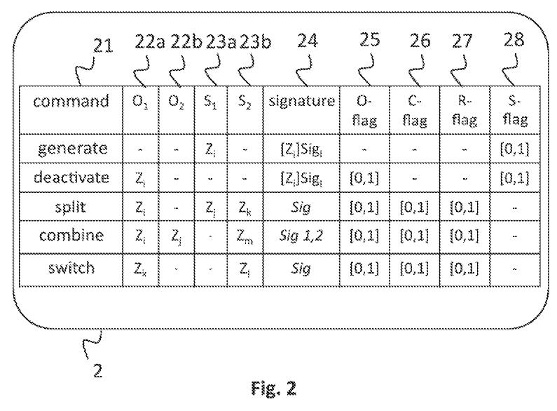

FIG. 2 shows an embodiment example of a monitoring entity 2 of FIG. 1. FIG. 2 shows an exemplary database in the form of a table in which the masked electronic coin data sets Zᵢ and, if applicable, their processing are registered. The monitoring entity 2 is preferably located locally remote from the terminals M1 to M3 and is housed, for example, in a server architecture.

Each processing operation for a processing (creating, deactivating, splitting, combining and switching) is thereby registered in the monitoring entity 2 and appended there in unchangeable form to a list of previous processing operations for masked electronic coin data sets Zᵢ. The individual operations or their check results, i.e. the intermediate results of a processing operation, are recorded in monitoring entity 2.

The processing operations “create” and “deactivate”, which concern the existence of the monetary amount νᵢ, per se, i.e., imply the creation and destruction of money, require additional authorization by the issuing entity 1 to be registered (i.e., logged) in the monitoring entity 2. The remaining processing operations (split, combine, switch) do not require authorization by issuing entity 1 or by the command initiator (= payer, e.g. the first terminal M1).

A registration of the respective processing in the monitoring entity 2 is realized, for example, by corresponding list entries in the database according to FIG. 2. Each list entry has further markers 25 to 28 documenting the intermediate results of the respective processing to be performed by the monitoring entity 2. Preferably, the markers 25 to 28 are used as an aid and are discarded by the monitoring entity after completion of the commands. What remains are markers 29 through 32 about the validity of the (masked) electronic coin data sets from columns 22a, 22b, 23a and/or 23b. These markers are in state “-” when a processing command is received, for example, and are set to state “1” when all checks have been successfully completed and are set to state “0” when at least one check has failed. A possible structure for a list entry of a coin data set comprises, for example, two columns 22a, 22b for a predecessor coin data set (O1, 02), two columns 23a, 23b for a successor coin data set (S1, S2), a signature column 24 for issuing entity/entities 1, and four marker columns 25 to 28. Each of the entries in columns 25 to 28 has three alternative states “1” or “0”. Column 25 (O flag) indicates whether a validity check was successful with respect to an electronic coin data set in column 22a/b, where state “1” indicates that a validity check revealed that the electronic coin data set of column 22a/b is valid and state “0” indicates that a validity check revealed that the electronic coin data set of column 22a/b is invalid and state indicates that a validity check has not yet been completed. Column 26 (C flag) indicates whether the calculation of the masked electronic coin data set was successful, where state “1” indicates that a calculation was successful and state “0” indicates that calculation was unsuccessful and the state indicates that a validity check has not yet been completed.

For example, the calculation to be performed in column 26 for fully masked coin data sets based on equation (3) is:

$$\left({Z}_{O 1} + {Z}_{O 2}\right) - \left({Z}_{S 1} + {Z}_{S 2}\right) = = 0$$

Column 27 (R flag) indicates whether a check of the range evidence or range proof was successful, where state “1” indicates that a validity check showed that the range evidence or range proof could or is traceable and state “0” indicates that a validity check showed that the range evidence or range proof could not or could not be traced and state “-” indicates that a validity check not yet completed was successful.

Column 28 (S flag) indicates whether a signature of the electronic coin record matches the signature of column 24, where state “1” indicates that a validity check revealed that the signature could be identified as that of the issuer and state “0” indicates that a validity check revealed that the signature could not be identified as that of the issuer and state “-” indicates that a validity check has not yet been completed.

A change in the state of any of the markers (also referred to as a “flag”) requires approval by the monitoring entity 2 and must then be stored immutably in the monitoring entity 2. A processing is final if and only if the required flags 25 to 28 have been validated by monitoring entity 2, i.e., changed from state “0” to state “1” or state “1” after the appropriate check.

To determine whether a masked electronic coin data set Z is valid, the monitoring entity 2 searches for the last change affecting the masked electronic coin data set Z. The monitoring entity 2 checks whether the masked electronic coin data set Z is valid. It is considered that the masked electronic coin data set Z is valid if and only if the masked electronic coin data set Z is listed for its last processing in one of the successor columns 23a, 23b and this last processing has the corresponding final mark 25 to 28. It also applies that the masked electronic coin data set Z is valid if and only if the masked electronic coin data set Z is listed for its last processing in one of the predecessor columns 22a, 22b and this last processing has failed, i.e. at least one of the corresponding required states of the markers 25 to 28 is set to “0”.

It also holds that the masked electronic coin data set Z is not valid for all other cases, for example if the masked electronic coin data set Z is not found in the monitoring entity 2 or if the last processing of the masked electronic coin data set Z is listed in one of the successor columns 23a, 23b but this last processing never became final or if the last processing of the masked electronic coin data set Z is in one of the predecessor columns 22a, 22b and this last processing is final.

The checks by the monitoring entity 2 to check whether a processing is final are represented by columns 25 to 28: The state in column 25 indicates whether the masked electronic coin data set(s) according to predecessor columns 22a, 22b are valid. The state in column 26 indicates whether the calculation of the masked electronic coin data set is correct according to equation (10). The state in column 27 indicates whether the range verifications for the masked electronic coin data set Z could be successfully checked. The state in column 28 indicates whether the signature in column 24 of the masked electronic coin data set Z is a valid signature of the issuing entity 1.

The state “0” in a column 25 to 28 indicates that the verification was not successful. The state “1” in a column 25 to 28 indicates that the verification was successful. The state “-” in a column 25 to 28 indicates that no check was performed. The states can also have a different value, as long as a clear distinction can be made between success/failure of a check and it is evident whether a particular check was performed.

As an example, five different processing operations are defined, which are explained in detail here. Reference is made to the corresponding list entry in FIG. 2.

For example, one processing is “generating” an electronic coin data set Cᵢ. Generating in the direct transaction layer 3 by the issuing entity 1 includes selecting a monetary amount νᵢ and generating an obfuscation amount rᵢ, as described earlier with equation (1). As shown in FIG. 2, the “generate” processing does not require any entries/markers in columns 22a, 22b, 23b and 25 to 27. In the successor column 23a, the masked electronic coin data set Zᵢ is registered. This registration is preferably performed before transfer to a terminal M1 to M3, in particular or already during generation by the issuing entity 1. In both cases, equation (3) or equation (3a) must be executed for this purpose. The masked electronic coin data set Zᵢ is signed by issuing entity 1 when it is generated, this signature is entered in column 24 to ensure that the electronic coin data set Cᵢ was actually generated by the issuing entity 1, although other methods may also be used for this purpose. If the signature of a obtained Cᵢ matches the signature in column 24, the marker in column 28 is set (from “0” to “1”). The markers according to columns 25 to 27 do not require a status change and can be ignored. The range verification is not needed because the monitoring entity 2 trusts that the issuing entity 1 does not issue negative monetary amounts. However, in an alternative embodiment, it can be sent by the issuing entity 1 in the create command and checked by monitoring entity 2.

For example, one processing is “deactivate.” Deactivating, i.e. destroying money (DESTROY), causes the masked electronic coin data set Zᵢ to become invalid after the issuing entity 1 has successfully executed the deactivate command. Thus, one can no longer process the (masked) electronic coin data set to be deactivated in monitoring layer 4. To avoid confusion, the corresponding (unmasked) electronic coin data sets Cᵢ should also be deactivated in the direct transaction layer 3. When “deactivating”, the predecessor column 22a is written to with the electronic coin data set Zᵢ, but no successor column 23a, 23b is occupied. The masked electronic coin data set Zᵢ shall be checked during deactivation to ensure that the signature matches the signature as specified in column 24 to ensure that the electronic coin data set Cᵢ was actually created by an issuing entity 1, although again other means may be used for this check. If the signed Cᵢ sent along in the deactivate command can be confirmed as signed by issuing entity 1 or confirmed as validly signed, marker 28 is set (from “0” to “1”). The markers according to columns 26 to 27 do not require a status change and can be ignored. The markers according to columns 25 and 28 are set after appropriate verification.

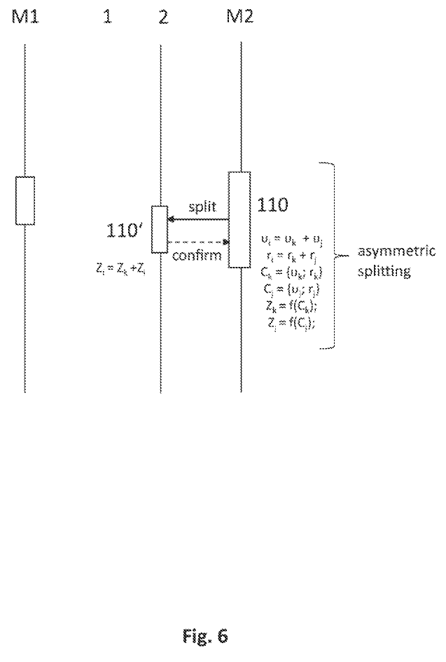

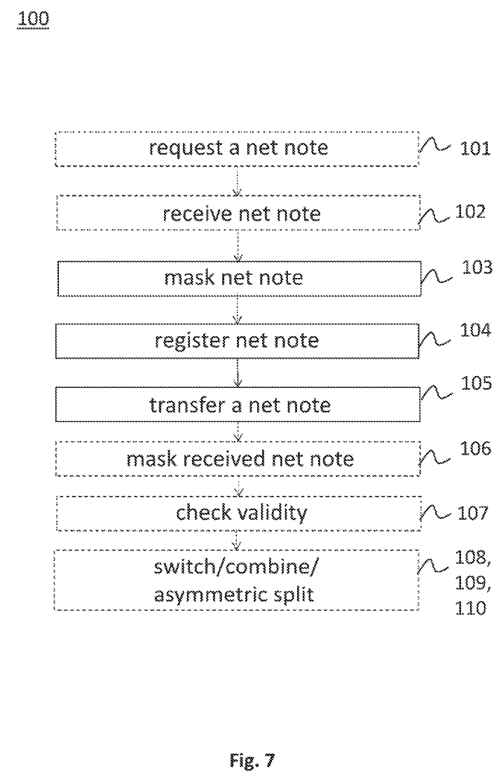

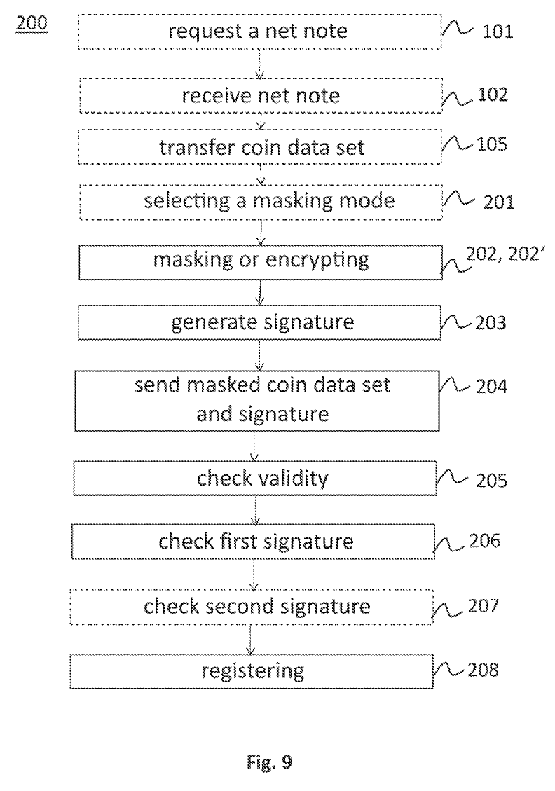

One processing is, for example, “split”. The splitting, i.e. the splitting of an electronic coin data record Zᵢ into a number n, for example 2, of electronic coin data records Zⱼ and Zₖ is first carried out in the direct transaction layer 3, as shown in FIGS. 3, 5 to 7 and also FIGS. 9 to 11, whereby the monetary amounts νⱼ and the obfuscation amount rⱼ are generated. vₖ and rₖ result from equations (7) and (8). In monitoring instance 2, markers 25 to 27 are set, predecessor column 22a is described by electronic coin record Zᵢ, successor column 23a is described by Zⱼ and successor column 23b is described by Zₖ. The status changes required according to columns 25 to 27 are made after the corresponding check by the monitoring instance 2 and document the respective check result. The marking according to column 28 is ignored. In column 24, a signature of the split coin record – masked with equation (3a) – can be entered.

One processing is for example “combine”. The combining, i.e., the merging of two electronic coin data sets Zᵢ and Zⱼ into one electronic coin data set Zₘ is first performed in the direct transaction layer 3, as will be shown in FIG. 4, where the monetary amount νₘ, and the obfuscation amount rₘ are calculated. In the monitoring entity 2, the markers 25 to 27 are set, the predecessor column 22a is described with the electronic coin data set Zᵢ, predecessor column 22b is described with Zⱼ and successor column 23b is described with Zₘ. The markers in columns 25 to 27 require status changes and the monitoring entity 2 performs the appropriate checks. A range verification must be performed to show that no new money has been generated. The marker according to column 28 is ignored. A first signature and a second signature of the coin data sets to be combined – masked with equation (3a) – can be entered in column 24.

One processing is, for example, “switching”. Switching is necessary when an electronic coin data set has been transferred to another terminal and re-issuing by the transferring terminal (here M1) is to be excluded. When switching, the electronic coin data set Cₖ obtained from the first terminal M1 is exchanged for a new electronic coin data set C₁ with the same monetary amount. The new electronic coin data set C₁ is generated by the second terminal M2. This switching is necessary to invalidate (make invalid) the electronic coin data set Cₖ obtained from the first terminal M1, thus avoiding re-issuing the same electronic coin data set Cₖ. This is because, as long as the electronic coin data set Cₖ is not switched, since the first terminal M1 is aware of the electronic coin data set Cₖ, the first terminal M1 can pass this electronic coin data set Cₖ to a third terminal M3. The switching is done, for example, by adding a new obfuscation amount r_{add} to the obfuscation amount rₖ of the received electronic coin data set Cₖ, thereby obtaining an obfuscation amount rₗ that only the second terminal M2 knows. This can also be done in the monitoring entity 2. To prove that only a new obfuscation amount r_{add} has been added to the obfuscation amount rₖ of the masked obtained electronic coin data set Zₖ, but the monetary amount has remained the same, and thus equation (11):

$${υ}_{k} = {υ}_{l}$$

holds, then the second terminal M2 must be able to prove that Zₗ-Zₖ can be represented as a scalar multiple of G i.e., as r_{add}^{∗}G. That is, only one obfuscation amount r_{add} has been generated and the monetary amount of Zₗ is equal to the monetary amount of Zₖ, i.e., Zₗ=Zₖ+ r_{add}^{∗}G. This is done by generating a signature with the public key Zₗ-Zₖ=r_{add}^{∗}G. This signature is used in monitoring layer 4 to confirm the validity of the electronic coin data set to be switched.

The “split” and “combine” modifications to an electronic coin data set can also be delegated from one terminal M1 to another terminal M2, M3, for example, when a communication link to the monitoring entity 2 is not available.

FIG. 3 shows an embodiment example of a payment system according to the invention for “splitting”, “combining” and “switching” electronic coin data sets C. In FIG. 3, the first terminal M1 has obtained the coin data set Cᵢ and now wishes to perform a payment transaction not with the entire monetary amount νᵢ, but only with a partial amount νₖ. For this purpose, the coin data set Cᵢ is split. To do this, the monetary amount is first split:

$${υ}_{i} = {υ}_{j} + {υ}_{k}$$

Here, each of the obtained amounts νⱼ, νₖ, must be greater than 0, because negative monetary amounts are not allowed.

In addition, new obfuscation amounts are derived:

$$r {}_{i} = {r}_{j} + {r}_{k}$$

When split, masked coin data sets Zⱼ and Zₖ are obtained from the coin data sets Cⱼ and Cₖ according to equation (3) and registered in monitoring entity 2. For splitting, the predecessor column 22a is written with coin data set Zᵢ, the successor column 23a is written with Zⱼ, and the successor column 23b is written with Zₖ. Additional information for range verification (zero-knowledge-proof) is to be generated. The markers in columns 25 to 27 require status change and the monitoring entity 2 performs the corresponding checks. The marker according to column 28 is ignored.

Then a coin partial data set, here Cₖ, is transferred from the first terminal M1 to the second terminal M2. To prevent double output, a switch operation is useful to exchange the electronic coin data set Cₖ obtained from the first terminal M1 for a new electronic coin data set C₁ with the same monetary amount. The new electronic coin data set C₁ is generated by the second terminal M2. In this process, the monetary amount of the coin data set C₁ is adopted and not changed, see equation (11).

Then, according to equation (14), a new obfuscation amount r_{add} is added to the obfuscation amount rₖ of the obtained electronic coin data set Cₖ,

$${r}_{l} = {r}_{k} + {r}_{a d d}$$

thereby obtaining an obfuscation amount rₗ known only to the second terminal M2. In order to prove that only a new obfuscation amount r_{add} has been added to the obfuscation amount rₖ of the obtained electronic coin data set Zₖ, but that the monetary amount has remained the same (νₖ= νₗ), the second terminal M2 must be able to prove that Zₗ-Zₖ can be represented as a multiple of G. This is done using public signature R_{add} according to equation (15):

$$\begin{matrix}{R}_{a d d} = {r}_{a d d} ⋅ G \\ = {Z}_{l} \text{-} {Z}_{k} = \left({v}_{l} \text{-} {v}_{k}\right) * H + \left({r}_{k} {r}_{a d d} \text{-} {r}_{k}\right) * G\end{matrix}$$

where G is the generator point of the ECC. Then, the coin data set Cₗ to be switched is masked using equation (3) or equation (3a) to obtain the masked coin data set Zₗ. In the monitoring entity 2, the private signature r_{add} can then be used to sign, for example, the masked switchable electronic coin data set Zₗ, which is considered as a proof that the second terminal M2 has only added an obfuscation amount r_{add} to the masked electronic coin data set and no additional monetary value, i.e. vₗ = vₖ.

The proof for masking using equation (3) is as follows:

$$\begin{matrix}{Z}_{k} = {υ}_{k} ⋅ H + {r}_{k} ⋅ G \\ {Z}_{l} = {υ}_{l} ⋅ H - {r}_{l} ⋅ G = {υ}_{k} ⋅ H + \left({r}_{k} + {r}_{a d d}\right) ⋅ G \\ {Z}_{l} - {Z}_{k} = \left({r}_{k} + {r}_{a d d} \text{-} {r}_{k}\right) ⋅ G \\ = {r}_{a d d} ⋅ G\end{matrix}$$

For maskings using equation (3a), a signature is generated over the monetary amount νₖ, the obfuscation amount rₖ and the masked coin data set Z (also referred to as R). Thus, the signature can be validated by recalculating the masking in the monitoring entity 4 to be able to prove the authenticity and existence/possession of the coin data set C.

FIG. 4 shows an embodiment example of a payment system according to the invention for combining electronic coin data sets. In this case, the two coin data sets Cᵢ and Cⱼ are obtained in the second terminal M2. Following the splitting according to FIG. 3, a new coin data set Zₘ is now obtained by adding both the monetary amounts and the obfuscation amount of the two coin data sets Cᵢ and Cⱼ. Then, the obtained coin data set Cₘ to be combined is masked using equation (3) or equation (3a) and the masked coin data set Zₘ is registered in the monitoring entity.

For maskings using equation (3a), a first signature is generated over the monetary amount νᵢ, the obfuscation amount rᵢ, and the masked coin data set Zᵢ, and a second signature is generated over the monetary amount νⱼ, the obfuscation amount rⱼ, and the masked coin data set Zⱼ. Both signatures can be validated by recalculating the masking in the monitoring entity 4, respectively, to be able to prove the authenticity and existence/possession of the coin data set C. The first signature may also be associated with the second signature to form a common signature.

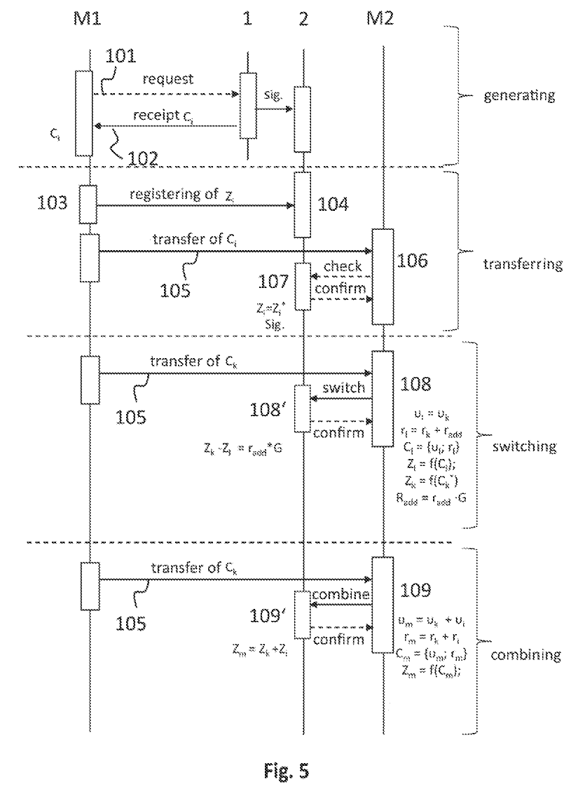

FIGS. 5 to 7 are each an embodiment of a method flowchart of a method 100 according to the invention. FIGS. 5 to 7 are explained together below. In optional steps 101 and 102, a coin data set is requested and provided on the part of the issuing entity 1 to the first terminal M1 after the electronic coin data set is created. A signed masked electronic coin data set is transmitted to the monitoring entity 2 in step 103. In step 103, masking of the obtained electronic coin data set Cᵢ is performed according to equation (3) and as explained in FIG. 1. Then, in step 104, the masked electronic coin data set Zᵢ is registered in the monitoring entity 2. Optionally, M1 can switch the obtained electronic coin data set. In step 105, the coin data set Cᵢ is transferred in the direct transaction layer 3 to the second terminal M2. In optional steps 106 and 107, a validity check with prior masking is performed, in which, in the good case, the monitoring entity 2 confirms the validity of the coin data set Zᵢ and Cᵢ, respectively.

In step 108, switching of a obtained coin data set Cₖ (of course, the obtained coin data set Cᵢ could also be switched) to a new coin data set Cₗ takes place, whereby the coin data set Cₖ becomes invalid and double spending is prevented. To do this, the monetary amount νₖ of the transferred coin data set Cₖ is used as the “new” monetary amount νₗ. In addition, as already explained with equations (14) to (17), the obfuscation amount rₗ is created. The additional obfuscation amount r_{add} is used to prove that no new money (in the form of a higher monetary amount) was generated by the second terminal M2. Then, among other things, the masked coin data set Zₗ to be switched is transmitted to the monitoring entity 2 and the switching from Cₖ to Cₗ is instructed.

In step 108', the corresponding check is carried out in monitoring entity 2, with Zₖ being entered in column 22a according to the table in FIG. 2 and the coin data set Zₗ to be switched being entered in column 23b. A check is then carried out in monitoring entity 2 to determine whether Zₖ is (still) valid, i.e. whether the last processing of Zₖ is entered in one of the columns 23a/b (as proof that Zₖ has not been further split or deactivated or combined) and whether a check for the last processing has failed. In addition, Zₗ is entered in column 23b and the markers in columns 25, 26, 27 are initially set to “0”. Now a check is made to see if Zₗ is valid, using the check according to equations (16) and (17). In the good case, the marker in column 25 is set to “1”, otherwise to “0”. Now a check is made, the calculation according to equation (10) shows that Zₖ and Zₗ are valid and accordingly the marker in column 26 is set. Further it is checked whether the ranges are conclusive, then the marker in column 27 is set. If all three checks were successful, and this was recorded accordingly unchangeably in the monitoring entity 2, the coin data set is considered switched. This means that the coin data set Cₖ is no longer valid and the coin data set Cₗ is valid from now on. Double issuance is no longer possible when a third terminal M3 inquires about the validity of the (double issued) coin data set at the monitoring entity 2.

In step 109, a combining of two coin data sets Cₖ and Cᵢ onto a new coin data set Cₘ is performed, making the coin data sets Cₖ, Cᵢ invalid and preventing double spending. To do this, the monetary amount nm is formed from the two monetary amounts νₖ and νᵢ. For this purpose, the obfuscation amount rₘ is formed from the two obfuscation amounts rₖ and rᵢ. In addition, using equation (3), the masked coin data set to be combined is obtained and this is transmitted (together with other information) to the monitoring entity 2 and combining is requested as processing.

In step 109', the corresponding check is performed in monitoring entity 2, with Zₘ being entered in column 23b according to the table in FIG. 2, which also equals a paraphrase. A check is then made in monitoring entity 2 whether Zₖ and Zᵢ are (still) valid, i.e. whether the last processing of Zₖ or Zᵢ is entered in one of the columns 23a/b (as proof that Zₖ and Zᵢ have not been further split or deactivated or combined) and whether a check for the last processing has failed. In addition, the markers in columns 25, 26, 27 are initially set to “0”. Now a check is made whether Zₘ is valid, whereby the check according to equations (16) and (17) can be used. In the good case the marker in column 25 is set to “1”, otherwise to “0”. Now a check is made, the calculation according to equation (10) shows that Zᵢ plus Zₖ equals Zₘ and accordingly the marker in column 26 is set. Further it is checked whether the ranges are conclusive, then the marker is set in column 27.

In step 110’, the corresponding check is performed in monitoring entity 2, where Zⱼ and Zₖ are entered in columns 23a/b according to the table in FIG. 2. A check is then made in monitoring entity 2 as to whether Zᵢ is (still) valid, i.e. whether the last processing of Zᵢ is entered in one of the columns 23a/b (as proof that Zᵢ has not been further split or deactivated or combined) and whether a check for the last processing has failed. In addition, the markers in columns 25, 26, 27 are initially set to “0”. Now a check is carried out whether Zⱼ and Zₖ are valid, whereby the check according to equations (16) and (17) can be used. In the good case, the marking in column 25 is set to “1”. Now a check is made, the calculation according to equation (10) shows that Zᵢ is equal to Zₖ plus Zⱼ and accordingly the marker in column 26 is set. Further it is checked whether the ranges are conclusive, then the marker is set in column 27.

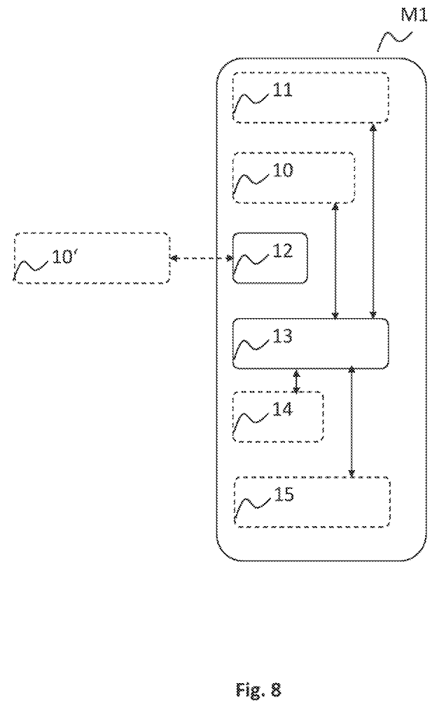

In FIG. 8, an embodiment example of a device M1 according to the invention is shown. The device M1 can store electronic coin data sets Cᵢ in a data memory 10, 10'. In this regard, the electronic coin data sets Cᵢ may reside on the data memory 10 of the device M1 or may be available in an external data memory 10'. When using an external data storage 10', the electronic coin data sets Cᵢ could be stored in an online storage, for example a data storage 10' of a digital wallet provider. Additionally, private data storage, for example a network attached storage, NAS on a private network could also be used.

In one case, the electronic coin data set Cᵢ is shown as a hard copy printout. In this case, the electronic coin data set may be represented by a QR code, an image of a QR code, or may be a file or a string (ASCII).

The device M1 has at least one interface 12 available as a communication channel for outputting the coin data set Cᵢ. This interface 12 is for example an optical interface, for example for displaying the coin data set Cᵢ on a display unit (display), or a printer for printing the electronic coin data set Cᵢ as a paper printout. This interface 12 can also be a digital communication interface, for example for near-field communication, such as NFC, Bluetooth, or an internet-capable interface, such as TCP, IP, UDP, HTTP, or an access to a smart card as a security element. For example, this interface 12 is a data interface such that the coin data set Cᵢ is transferred between devices via an application, such as an instant messenger service, or as a file or string.

Moreover, the interface 12 or another interface (not shown) of the device M1 is arranged to interact with the monitoring entity 2 as described in FIGS. 1 to 6. The device M1 is preferably online-capable for this purpose.

Furthermore, the device M1 may also have an interface for receiving electronic coin data sets. This interface is set up to receive visually presented coin data sets, for example by means of an acquisition module such as a camera or scanner, or digitally presented coin data sets, received via NFC, Bluetooth, TCP, IP, UDP, HTTP, or coin data sets presented by means of an application.

The device M1 also comprises a computing unit 13 capable of performing the method described above for masking coin data sets and the processing operations on coin data sets.

The device M1 is capable of being online and can preferably detect when it is combined with a WLAN by means of a location detection module 15. Optionally, a specific WLAN network can be marked as preferred (=location zone), so that the device M1 executes special functions only if it is logged into this WLAN network. Alternatively, the location detection module 15 detects when the device M1 is in predefined GPS coordinates including a defined radius and performs the special functions according to the location zone thus defined. This location zone can be introduced into the device M1 either manually or via other units/modules. The special functions performed by the device M1 when the location zone is detected are, in particular, the transfer of electronic coin data sets from/to the external data memory 10 from/to a vault module 14 and, if necessary, the transfer of masked coin data sets Z to the monitoring entity 2, for example as part of the above-mentioned processing operations on a coin data set.

In the simplest case, all coin data sets Cᵢ are automatically combined into one coin data set in the terminal M1 upon obtaining (see connect processing or connect step). That is, as soon as a new electronic coin data set is received, a combine or switch command is transmitted to the monitoring entity 2. The device M1 can also prepare electronic coin data sets in algorithmically defined denominations and hold them in the data memory 10, 10’ so that a payment process is possible even without a data connection to the monitoring entity 2.

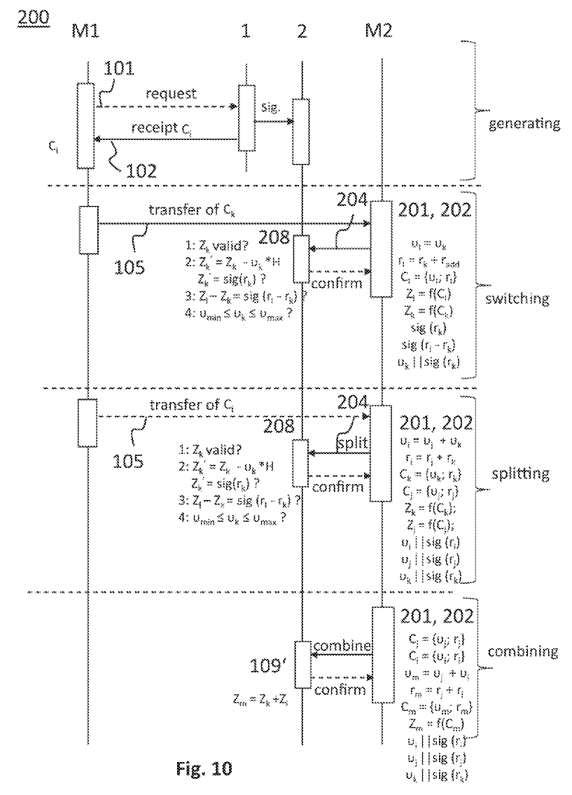

FIGS. 9 and 10 each show an embodiment of a method flow diagram of a method 200 according to the invention. In the following, FIGS. 9 and 10 are explained together.

explained. The statements made previously from the method 100 and the individual method steps 101 to 110 also apply to this method 200, unless other statements are made here.

In the optional steps 101 and 102, a coin data set is requested and provided on the part of the issuing entity 1 to the first terminal M1 after the electronic coin data set has been created, see also FIGS. 5 to 7. The first terminal M1 transfers the coin C to the second terminal in step 105. Although the method steps 201 to 208 shown here are explained with respect to the second terminal M2, they could also be performed in the first terminal M1. In step 105, the first terminal M1 transfers the coin Cₖ to the second terminal.

In step 201, selecting a masking mode is performed. To prevent double issuance, a switch operation (switch) is provided to exchange the electronic coin data set Cₖ obtained from the first terminal M1 for a new electronic coin data set C₁ having the same monetary amount. The new electronic coin data set C₁ is generated by the second terminal M2. The monetary amount νₖ of the coin data set Cₖ is taken over and is not changed to the new monetary amount νₗ, see equation (11). Then, according to equation (14), a new obfuscation amount r_{add} is added to the obfuscation amount rₖ of the obtained electronic coin data set Cₖ, obtaining an obfuscation amount rₗ that only the second terminal M2 knows.

The selection is made, for example, by a user of the first terminal M1 via a corresponding menu control on the terminal M1. The selection is made, for example, on the basis of a system default x in the payment system. For example, in this way, a performance of the payment system can be optimally utilised so that an effort of verification (step 207) can be controlled based on a current registration request volume in the monitoring entity 2 by selecting the masking mode accordingly. The selection may also be selected based on a terminal property, for example, if one of the masking modes is not supported, an appropriate preselection may be made.

In order not to have to carry out the time-consuming verification of equations (15) and (16), the second masking mode is now selected in step 201 according to FIG. 9. Then, in step 202, the electronic coin data set C₁ is masked according to equation (3) to obtain the masked electronic coin data set Zₗ.

In step 203, a first signature is created using the obfuscation amount rₖ as the signature key according to equation (17):

$$\left[{Z}_{k}\right] s i g \left({r}_{k}\right)$$

In addition, in step 203, a second signature is created with the difference of the obfuscation amounts rᵢ and rₗ as signature key according to equation (18):

$$\left[{Z}_{k}\right] s i g \left({r}_{l} - {r}_{k}\right)$$

In addition, the monetary amount νₖ of the received electronic coin data set Cₖ is added to the first signature, here as an example logically ORed according to equation (19):

$${υ}_{k} \left‖s i g \left({r}_{k}\right)\right)$$

The switching (modifying) is preferably done before the sending step 204. The corresponding incompletely masked electronic coin data set Zₗ sent to the monitoring entity 2 in step 204 is sent together with at least also the unmasked data element from equation (19) and the second signature from equation (18):

$${υ}_{k} \left‖s i g \left({r}_{k}\right) ; s i g \left({r}_{l} - {r}_{k}\right) ; {Z}_{l}\right)$$

In the monitoring entity, a simplified range check can be performed by selecting the second masking mode. This comprises four checks here. The first check is to check the validity (validity) of the incompletely masked coin data set to be switched. This is done in the same way as described above.

The second check according to step 206 is to verify the first signature. For this purpose, the public verification key of the first signature is created from the unmasked monetary amount νₖ, with:

$${Z}_{k} {}^{′} = {Z}_{k} - {υ}_{k} * H$$

The public verification key generated in equation (21) is used to check the first signature:

$${Z}_{k} {}^{′} = s i g \left({r}_{k}\right)$$

If the second verification is successful, it is proven that the monetary amount νₖ belongs to the masked coin data set Zₖ and that the second terminal M2 knows the obfuscation amount rₖ.

The third check according to step 207 serves to verify the second signature. For this purpose, the difference between the masked electronic coin data set Zᵢ to be switched and the masked obtained coin data set Zₖ is formed:

$${Z}_{l} - {Z}_{k} = s i g \left({r}_{l} - {r}_{k}\right)$$

The public verification key generated in equation (23) is used to check the second signature. If the third verification is successful, it is proven that the difference in monetary amounts νₖ νₗ is zero, thus proving that no new/additional money has been generated.

The fourth check is then a very simple area check by the monitoring entity 2:

$${υ}_{m i n} \leq {υ}_{k} \leq {υ}_{m a x}$$

Checking the splitting (as modifying) of a coin data set Cᵢ is done in a comparable way to switching. For example, in step 105, the first terminal M1 transfers the coin Cᵢ to the second terminal M2.

In step 201, the masking mode is selected. In order not to have to carry out the time-consuming verifications of equations (15) and (16), the second masking mode is now selected in step 201 according to FIG. 9. Then, in step 202, the electronic coin data set Cᵢ is split according to equations (6) and (7) to obtain a first coin partial data set Cⱼ and a second coin partial data set Cₖ. In step 203, three separate first signatures are then created over the obfuscation amounts rᵢ, rⱼ, and rₖ according to equation (17). In addition, each of the monetary amounts νᵢ νⱼ νₖ is added to the corresponding first signature, by way of example, logically ORed according to equation (19), so that the following three first signatures are obtained:

$$υ {}_{i} \vert \vert s i g \left({r}_{i}\right)$$

$${υ}_{j} \left‖s i g \left({r}_{j}\right)\right)$$

$${υ}_{k} \left‖s i g \left({r}_{k}\right)\right)$$

The splitting (modifying) is preferably done before the transmitting step 204. The corresponding incomplete masked electronic coin partial data sets Zₖ Zⱼ transmitted to the monitoring entity 2 in step 204 are transmitted together with the unmasked data elements from equations (19a), (19b), (19c):

$${υ}_{k} \left‖s i g \left({r}_{k}\right) ;\right) {υ}_{i} \left‖s i g \left({r}_{i}\right) ;\right) {υ}_{j} \left‖s i g \left({r}_{j}\right) ;\right) {Z}_{j ;} {Z}_{k}$$

In the monitoring entity 2, a simplified area check can be carried out by selecting the second masking mode. This also comprises four checks here. The first check is to check the validity (validity) of the incompletely masked coin data set to be switched. This is done in the same way as described above.

The second check according to step 206 is to verify the first signature over the obfuscation amount rᵢ of the unsplit coin data set Cᵢ. The second verification is performed according to equations (21) and (22). If the second check is successful, it is verified that the monetary amount υᵢ belongs to the masked coin data set Zᵢ and that the second terminal M2 knows the obfuscation amount rᵢ.

The third check according to equation (26) serves to prove that no additional money was generated with:

$$\left({Z}_{j} + {Z}_{k}\right) - {Z}_{i} - - 0$$

The fourth check is then a calculation of the respective public verification keys to check the remaining first signatures with:

$${Z}_{j} {}^{′} - {Z}_{j} - {υ}_{j} * H$$

$${Z}_{k} ' = {Z}_{k - υ k} * H$$

The public verification keys generated in equations (27) and (28) are used to check the respective first signature:

$${Z}_{k} ' = s i g \left({r}_{k}\right)$$

$${Z}_{j} ' = s i g \left({r}_{j}\right)$$

If the fourth check is successful, it is verified that the monetary amount υₖ belongs to masked coin data set Zₖ, that the monetary amount υⱼ belongs to masked coin data set Zⱼ and that the second terminal M2 knows the obfuscation amounts rₖ and rⱼ. Finally, a very simple range check can be performed analogous to equation (24).

Checking the combining (as modifying) of two coin data sets Cᵢ and Cⱼ into one combined coin data set Cₘ is performed in a similar manner. In step 201, the masking mode is selected. In order not to have to carry out the time-consuming verifications of equations (15) and (16), the second masking mode is now selected in step 201 according to FIG. 9. Then, in step 202, the linked electronic coin data set Cₘ is formed according to equations (6) and (7). Then, in step 203, the three separate first ones are again formed according to equations (19a) to (19c).

The combining (modifying) is preferably done before the transmitting step 204. The corresponding incomplete masked combined electronic coin data set Zₘ transmitted to the monitoring entity 2 in step 204 is transmitted together with the unmasked data elements from equations (19a), (19b), (19c):

$${υ}_{k} \left|\right| s i g \left({r}_{k}\right) ; {υ}_{i} \left|\right| s i g \left({r}_{i}\right) ; {υ}_{j} \left|\right| s i g \left({r}_{j}\right) ; {Z}_{m}$$

In the monitoring entity 2, a simplified area check can be carried out by selecting the second masking mode. This also comprises four checks here. The first check is to check the validity (validity) of the incompletely masked coin data set to be switched. This is done in the same way as described above.

The second check is to verify the first signature over the obfuscation amount rᵢ of the unsplit coin data set Cᵢ. The second verification is carried out according to equations (21) and (22). If the second check is successful, it is verified that the monetary amount υᵢ belongs to the masked coin data set Zᵢ and that the second terminal M2 knows the obfuscation amount rᵢ.

The third check is analogous to equation (26) and serves as proof that no additional money was generated.

The fourth check is then a calculation of the respective public verification keys to check the remaining first signatures analogous to equations (27) to (30). Finally, a very simple range check can be performed analogous to equation (24).

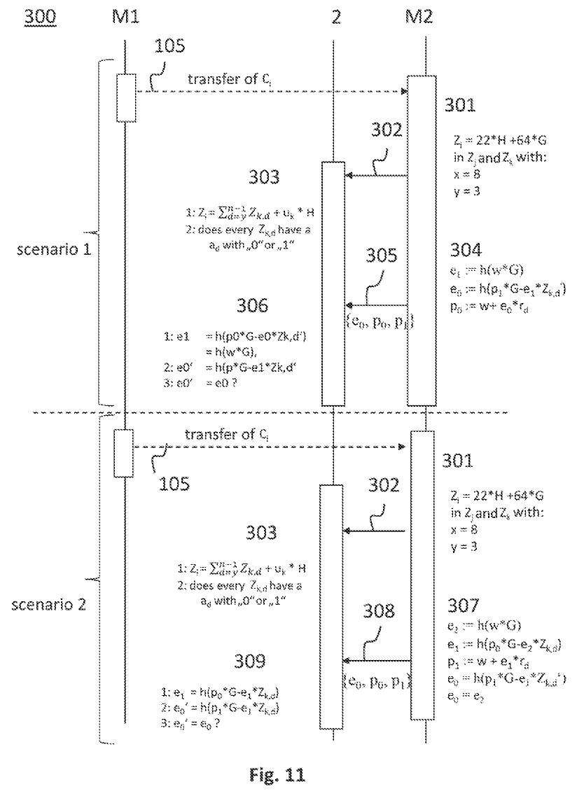

FIG. 11 shows another embodiment example of a method flowchart of a method 300 according to the invention. The method presented in FIG. 11 can be fully applied to any of the previously described methods. It is applicable to all three masking modes in the context of the simplified verification test.

The second terminal M2 is in possession of the electronic coin data set Cᵢ, for example by transferring it in step 105. The second terminal can now process the coin data set Cᵢ according to one of the previously described modifying steps, split, combine, switch. To facilitate a range check for a monitoring entity, the following steps are performed:

In the terminal M2, after the masking step (of the type described previously), the masked electronic coin data set is split into:

$${Z}_{i} = {Z}_{j} + {Z}_{k} = \left({υ}_{j} * H\right) + \left({υ}_{k} * {2}^{y} * H + {r}_{k} * G\right)$$

where υⱼ is less than a default value x. The default value x is, for example, predefined by the system or obtained by negotiation between two participants in the payment system. The default value x can be fixed as a payment system parameter or variable, for example negotiated between terminals.

A bitwise representation of x, assuming that

$$x = {2}^{y}$$

is made as an example of a place value based split of the masked coin subset Zₖ into Zₖ,_{d} with base 2 with:

$${Z}_{k} = {\sum }_{d = y}^{n - 1} {Z}_{k , d} = {\sum }_{d = y}^{n - 1} \left({v}_{k , d} ∗ {2}^{y} ∗ H + {r}_{k , d} ∗ G\right) = {\sum }_{d = y}^{n - 1} \left({a}_{k} {2}^{d} ∗ H + {r}_{k} ∗ G\right)$$

where ^{aⱼ} ^{∈ {0,1}}. The obfuscation amount r is chosen with:

$$r = {\sum }_{d = y}^{n - 1} {r}_{d}$$

Example 1 : For example, the masked obtained electronic coin data set Zᵢ = 22 ^{∗} H + 64 ^{∗} G and the default value x is eight. A bitwise representation of the monetary amount υᵢ is 1 0 1 1 0 with y = 3, see step 301 in FIG. 11.

The bitwise representation of the monetary amount υⱼ is then 110 (as υⱼ = 6) and Zⱼ= 6^{∗}H, the right y-th bits of the monetary amount υᵢ are considered.

The bitwise representation of the monetary amount υₖ is then 10000 (as υₖ = 16) and Zⱼ= 6^{∗}H, when the y-th bits of the monetary amount of υᵢ are set equal to zero. The second masked coin partial data set Zₖ is then:

$$\begin{matrix}{Z}_{k} = 16 * H + 64 * G \\ = \left(0 * {2}^{3} * \left(H\right| 20 * G\right) \left|\left(1 * {2}^{4} * H 44 * G\right)\right) \\ = {Z}_{k , 3} + {Z}_{k , 4}\end{matrix}$$

The verification check is then as follows:

The second terminal M2 sends the monetary amount υₖ and the list of Zₖ,_{d} from equation (34) for y < d < n to the monitoring entity 2 in step 302. The monitoring entity 2 checks in step 303 whether:

$${Z}_{i} = {\sum }_{d = y}^{n - 1} {Z}_{k , d} + {υ}_{j} ∗ H$$

If the check fails, the command is rejected. If the check is successful, the monitoring entity 2 proves that there is a corresponding a_{d} with “0” or “1” for each Zₖ,_{d} without disclosing the values. A range check is successful if there is a value of “0” or “1” for each a_{d}. A ring signature is used for this purpose. With a ring signature, anyone can prove for two or more public keys that the corresponding private keys are known, namely:

Scenario 1: Let it hold:

$${\text{Z}}_{\text{k,d}} = {\text{r}}_{\text{d}} * \text{G}$$

$${\text{Z}}_{\text{k,d}} ' : = - {\text{H+r}}_{\text{d}} * \text{G}$$

For this purpose, a random number w is created in the second terminal M2 in step 304 and calculated from it:

$${\text{e}}_{1} : = \text{h} \left(\text{w*G}\right)$$

where h is a hash function and G is the generator point of the ECC curve. Next, the terminal M2 creates a second random number p₁ and calculates:

$${\text{e}}_{0} : = \text{h} \left({\text{p}}_{1} * {\text{G-e}}_{1} * {\text{Z}}_{\text{k,d}} {}^{′}\right)$$

$${\text{p}}_{0} : = {\text{w+e}}_{0} * \text{rd}$$

and transmits the ring signature {eo, po, po} to the monitoring entity 2 in step 305. The monitoring entity 2 calculates:

$${\text{e}}_{1} = \text{h} \left({\text{p}}_{0} * {\text{G-e}}_{0} * {\text{Z}}_{\text{k,d}} {}^{′}\right)$$

Substituting equation (39) for p₀ and (38) for Zₖ,_{d} yields equation (44):

$${\text{e}}_{1} = \text{h} \left(\left({\text{w+e}}_{0} * {\text{r}}_{\text{d}}\right) {\text{G-e}}_{0} * {\text{r}}_{\text{d}} * \text{G}\right) = \text{h} \left(\text{w*G}\right) ,$$

which corresponds to the original e₁ as defined in the second terminal M2. The monitoring entity 2 calculates:

$${\text{e}}_{0} ' = \text{h} \left({\text{p*G-e}}_{1} * {\text{Z}}_{\text{k,d}} {}^{′}\right)$$

and checks whether e₀’= e₀ is correct. Under the assumption that

$${\text{Z}}_{\text{k,d}} {}^{′} = {\text{x*H+r}}_{\text{d}} * \text{G} \text{and x not equal 0}$$

holds:

$${\text{e}}_{1} = \text{h} \left({\text{p}}_{0} * {\text{G-e}}_{0} * {\text{Z}}_{\text{k,d}}\right) = \text{h} \left({\text{w*G-e}}_{0} * \text{x*H}\right)$$

which establishes that the second terminal M2 pi with e₀ = h(s₁^{∗}G-e₁∗Z_{k,d}).

Scenario 2:

$${\text{Z}}_{\text{k,d}} {\text{=H+r}}_{\text{d}} ∗ \text{G}$$

$${\text{Z}}_{\text{k,d}} {}^{′} : = {\text{r}}_{\text{d}} ∗ \text{G}$$

For this, a random number w is created and calculated in the second terminal M2 in step 307:

$${\text{e}}_{2} : = \text{h} \left(\text{w} ∗ \text{G}\right)$$

where h is a hash function and G is the generator point of the ECC curve. Next, the terminal M2 creates a second random number p₀ and calculates:

$$\text{e1} : = \text{h} \left({\text{p}}_{0} ∗ {\text{G-e}}_{2} ∗ {\text{Z}}_{\text{k,d}}\right)$$

$${\text{p}}_{1} : = {\text{w+e}}_{1} ∗ {\text{r}}_{\text{d}}$$

The terminal M2 also calculates in step 307:

$${\text{e}}_{0} = \text{h} \left({\text{p}}_{1} * {\text{G-e}}_{1} * {\text{Z}}_{\text{k,d}} '\right)$$

This results in

$${\text{e}}_{0} = \text{h} \left(\left({\text{w+e}}_{1} * {\text{r}}_{\text{d}}\right) * {\text{G-e}}_{1} * {\text{r}}_{\text{d}} * \text{G}\right) = \text{h} \left(\text{w*G}\right) = {\text{e}}_{2}$$

The terminal M2 transmits the ring signature {e₀, p₀, p₁} to the monitoring entity 2 in step 308. The monitoring entity 2 calculates in step 309:

$$\begin{matrix}{\text{e}}_{1} = \text{h} \left({\text{p}}_{0} * {\text{G-e}}_{1} * {\text{Z}}_{\text{k,d}}\right) \\ {\text{e}}_{0} ' = \text{h} \left({\text{p}}_{1} * {\text{G-e}}_{1} * {\text{Z}}_{\text{k,d}}\right)\end{matrix}$$

and checks whether e₀′= e₀ is true. Under the assumption that

$${\text{Z}}_{\text{k,d}} ' = {\text{x*H+r}}_{\text{d}} * \text{G} \text{with} \text{x} \text{not} \text{equal} \text{0}$$

holds:

$$\begin{matrix}{\text{e}}_{0} = \text{h} \left({\text{p}}_{1} * {\text{G-e}}_{1} * {\text{Z}}_{\text{k,d}} '\right) \\ = \text{h} \left({\text{w+e}}_{1} * {\text{r}}_{d}\right) * {\text{G-e}}_{1} * {\text{r}}_{\text{d}} * {\text{G-e}}_{1} * \text{x*} \left(\text{H}\right) \\ = \text{h} \left({\text{k*G-e}}_{1} * \text{x*H}\right) = {\text{e}}_{2}\end{matrix}$$

which establishes that the second terminal M2 p₀ with

$$\begin{matrix}{\text{e}}_{1} = \text{h} \left({\text{p}}_{0} ∗ {\text{G - e}}_{2} ∗ {\text{Z}}_{\text{k,d}}\right) \\ \left(= \text{h} \left({\text{p}}_{0} {\text{- e}}_{2} ∗ {\text{r}}_{\text{d}}\right) ∗ {\text{G - e}}_{2} ∗ \text{H}\right)\end{matrix}$$

must be found.

Example 2 is not shown figuratively and exemplifies an example in which the place value has an arbitrary base, i.e., contrary to Example 1, it has no base 2. Under the assumption of equation (34) then holds:

A stellar value-wise representation of x, assuming that b is an arbitrary basis

$$x = {b}^{y}$$

occurs as an example of a place value-based split of the masked coin subset Zₖ into Zₖ,_{d} with:

$${Z}_{k} = {\sum }_{d = y}^{n - 1} {Z}_{k , d} = {\sum }_{d = y}^{n - 1} \left({v}_{2 , d} ∗ {b}^{y} ∗ H + {r}_{2 , d} ∗ G\right) = {\sum }_{d = y}^{n - 1} \left({a}_{d} {b}^{d} ∗ H + {r}_{d} ∗ G\right)$$

Where aⱼ ∈ {0, ..., b}. The obfuscation amount r is chosen with:

$$r = {\sum }_{d = y}^{n - 1} {r}_{d}$$

Example 2: For example, the masked obtained electronic coin data set is again Zᵢ = 22 ^{∗} H + 64 ^{∗} G (in analogy to step 301), but here the default value is x = 9. A ternary representation of the monetary amount υᵢ is 2 1 1 with y = 2.

The ternary representation of the monetary amount υⱼ is then 0 1 1 (as υⱼ = 4) and Zⱼ= 4^{∗}H, the right y-th bits of the monetary amount υᵢ are considered.

The ternary representation of the monetary amount υₖ is then 200 (as υₖ = 18) when the y-th digits of the monetary amount of υᵢ are set equal to zero. The second masked coin partial data set Zₖ is then:

$$\begin{matrix}{Z}_{k} = 18 * H + 64 * G \\ = \left(2 * {3}^{2} * H + 64 * G\right) \\ = {Z}_{k , 2}\end{matrix}$$

The verification check is then as follows. The second terminal M2 sends (in analogy to step 302) the monetary amount υₖ and the list of Zₖ,_{d} from equation (34) for y ≤ d < n to the monitoring entity 2. The monitoring entity 2 checks (in analogy to step 303) according to equation (37).

If the check fails, the command is rejected. If the check is successful, monitoring entity 2 proves that for each Zₖ,_{d} there is a corresponding a_{d} with “0 or n” in the range “0 < n < b” without disclosing the values. A range check is successful if there is a value of 0 < n < b for each a_{d}. A ring signature is used for this purpose. With a ring signature, anyone can prove for two or more public keys that one of the corresponding private keys are known, namely. Ring signatures are described in MAXWELL et.al. “Borromean Ring Signatures,” Jun. 14, 2015, available at:

https://github.com/Blockstream/borromean_paper/raw/master/borromean_draft_0.01_8c3f9e7.pdf described and it is recommended for creating and applying and checking ring signatures to the entire disclosure in MAXWELL et.al. “Borromean Ring Signatures.”

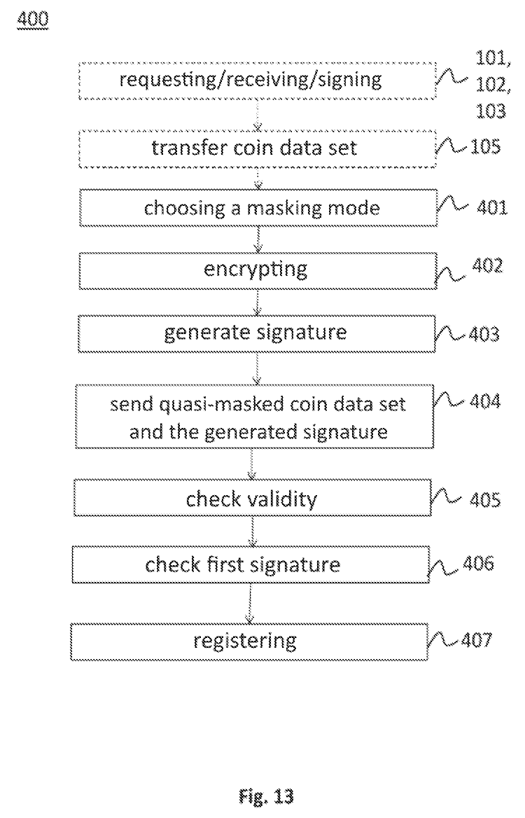

FIGS. 12 and 13 show a further embodiment of a method 400 according to the invention. FIGS. 12 and 13 are described together. The statements previously made from the method 100, 200 and 300 and the individual method steps also apply to this method 400, unless other statements are made herein.

First, the creation of a coin data set for the method 400 is described. In steps 101 and 102, a coin data set is requested and provided on the part of the issuing entity 1 to the first terminal M1 after the electronic coin data set has been created, see also FIGS. 5 to 7. The electronic coin data set Cᵢ has, for example, the structure according to equation (1). The issuing entity 1 calculates a quasi-masked coin data set Zᵢ for the electronic coin data set Cᵢ according to equation (3a), which has the structure according to equation (63):

$${Z}_{l} = \left\{{υ}_{l} ; {R}_{l}\right\}$$

, where the value Rᵢ is defined according to equation (64):

$${R}_{i} = {r}_{i} ⋅ G$$

G is – like G of equation (3) – a generator point of an elliptic curve cipher, ECC, – i.e. a private key of the ECC. The issuing entity 1 generates a signature according to equation (65) using a private signature key PK₁ of issuing entity 1:

$${υ}_{i} ; {R}_{i} s i g \left(P {K}_{1}\right)$$

A signed quasi-masked electronic coin data set is transmitted to monitoring entity 2 in step 103.

The procedure for switching a coin data set Cₖ is as follows. The first terminal M1 transfers the coin Cₖ to the second terminal M2 in step 105. Although the method steps 401 to 407 shown here are explained with respect to the second terminal M2, they could also be performed in the first terminal M1.

In step 401, which corresponds to step 201 of the method 200, a masking mode is (optionally) selected. To prevent double issuing, a switch operation is provided to exchange the electronic coin data set Cₖ obtained from the first terminal M1 for a new electronic coin data set C₁ having the same monetary amount. The new electronic coin data set C₁ is generated by the second terminal M2. The monetary amount υₖ of the coin data set Cₖ is taken over and is not changed to the new monetary amount υₗ, see also equation (11). Then, according to equation (14), a new obfuscation amount r_{add} is added to the obfuscation amount rₖ of the obtained electronic coin data set Cₖ, obtaining an obfuscation amount r₁ that only the second terminal M2 knows.

The selection according to step 401 is made, for example, by a user of the first terminal M1 via a corresponding menu control on the terminal M1. The selection is made, for example, on the basis of a system default using the default value x in the payment system. For example, in this way, a performance of the payment system can be optimally utilised so that an effort of verification (see also step 207) can be controlled based on a current registration request volume in the monitoring entity 2 by selecting the masking mode accordingly. The selection can also be selected based on a terminal property, for example, if one of the masking modes is not supported, an appropriate preselection can be made.

In order not to have to carry out the time-consuming verification of equations (15) and (16), the third masking mode is now selected in step 401 according to FIG. 12. Then, in step 402, the electronic coin data set Cₖ is masked according to equations (63), (64) to obtain the masked electronic coin data set Zₖ. In addition, the obfuscation amount is encoded using equation (64).

Then, in step 403, a first signature is created according to equation (66):

$$[ Z k ; {R}_{l} ] s i g \left({r}_{k}\right)$$

This first signature is generated using the quasi-masked electronic coin data set Zₖ created in step 402 and the encrypted obfuscation amount R₁ created in step 402 with the obfuscation amount r₁ as the signature key of the first signature.

The switching (as modifying) is preferably performed before the transmitting step 204. The quasi-masked electronic coin data set Z₁ generated in step 404 to the monitoring entity 2 is transmitted together with the signature generated in equation (66).

In monitoring entity 2, a simplified area check can be performed – due to the choice of the third masking mode. This comprises two checks. The first check according to step 405 is to check the validity (validity) of the quasi-masked coin data set to be switched. This is done in the same way as described above.

The second check according to step 406 is to verify the first signature. For this purpose, the encrypted obfuscation amount R₁ of the quasi-masked coin data set Z₁ is used as the public verification key of the first signature and it is checked whether the first signature transferred along in step 404 is valid according to equation (66). If both checks are successful, the coin data set c₁ is considered valid and a registration by the monitoring entity 2 takes place in step 407.

Checking the splitting (as modifying) of a coin data set Cᵢ is done in a similar way as switching. For example, the first terminal M1 transfers the coin Cᵢ to the second terminal M2 in step 105.

In step 401, the masking mode is selected. In order not to have to perform the elaborate verifications of equations (15) and (16), the third masking mode is now selected in step 401. Then, in step 402, the electronic coin data set Cᵢ is split according to equations (6) and (7) to obtain a first coin partial data set Cⱼ and a second coin partial data set Cₖ. In addition, the obfuscation amounts rᵢ, rₖ, r₁ are encoded into Rᵢ, Rₖ, and R₁ using equation (64).

Then, in step 403, a first signature is created according to equation (67):

$$[ {Z}_{i} ; {Z}_{k} ; {Z}_{l} ] s i g \left({r}_{i}\right)$$

The splitting (modifying) is preferably done before the transmitting step 404. The quasi-masked electronic coin partial data sets Zₖ Zⱼ transmitted to the monitoring entity 2 in step 404 are sent together with the first signature from equation (67):

$$\left[{Z}_{i} ; {Z}_{k} ; {Z}_{l}\right] s i g \left({r}_{i}\right) ; {Z}_{j ;} {Z}_{k}$$

In monitoring entity 2, a simplified range check can now be performed. This comprises here four checks. The first check is to check the validity of the incompletely masked coin data set to be switched. This is done according to the previous described type.

The second check according to step 406 is to verify the first signature. For this purpose, the encrypted obfuscation amount Rᵢ of the quasi-masked coin data set Zᵢ is used as the public verification key of the first signature and it is checked whether the first signature transferred along in step 404 is valid according to equation (67).

The third verification according to equation (69) is used to prove that no additional money was generated with:

$${υ}_{i} = = {υ}_{k} + {υ}_{l}$$

The fourth check is then a range check in monitoring entity 2 with:

$${υ}_{m i n} \leq {υ}_{k} \leq {υ}_{m a x}$$

$${υ}_{m i n} \leq {υ}_{l} \leq {υ}_{m a x}$$

If all four checks are successful, the quasi-masked coin data set Zᵢ becomes invalid and the coin partial data sets Zₖ and Z₁ become valid and correspondingly registered in the monitoring entity.

Checking the combining (as modifying) of two coin data sets Cᵢ and Cⱼ into one combined coin data set Cₘ is done in a similar way. In step 401, the masking mode is selected. In order not to have to perform the elaborate proofs of equations (15) and (16), the third masking mode is selected in step 401. According to equations (63), (64), the obfuscation amounts rᵢ, rⱼ, rₘ are scrambled to Rᵢ, Rⱼ, and Rₘ using equation (64) to obtain Zᵢ, Zⱼ, and Zₘ. Then, in step 403, a first signature is created according to equation (72):

$$\left⌈{Z}_{i} ; {Z}_{j} ; {Z}_{m}\right⌉ s i g \left({r}_{i}\right)$$

Then, in step 403, the first signature is re-signed according to equation (72):

$$\left[\left[{Z}_{i} ; {Z}_{j} ; {Z}_{m}\right] s i g \left({r}_{i}\right)\right] s i g \left({r}_{j}\right)$$

The combining (modifying) is preferably done before the transmitting step 404. The quasi-masked electronic coin partial data set Zₘ transmitted to the monitoring entity 2 in step 404 is transmitted together with the signature from equation (74):

$$\left[\left[{Z}_{i} ; {Z}_{j} ; {Z}_{m}\right] s i g \left({r}_{i}\right)\right] s i g \left({r}_{j}\right) ; {Z}_{m}$$

A simplified range check can now be carried out in monitoring entity 2. This comprises four checks. The first check is to check the validity of the incompletely masked coin data set to be switched. This is done in the same way as described above.

The second check according to step 406 is to verify the signature from equation (73) and the first signature from equation (72). For this purpose, the encrypted obfuscation amount Rᵢ of the quasi-masked coin data set Zᵢ or the encrypted obfuscation amount Rⱼ of the quasi-masked coin data set Zⱼ is used as a public verification key, respectively, and it is checked whether the signature(s) transferred along in step 404 according to equations (72) and (73) are valid.

The third check according to equation (75) is used to verify that no additional money was generated with:

$${υ}_{m} = = {υ}_{i} + {υ}_{j}$$

The fourth check is then a range test in monitoring entity 2 with:

$${υ}_{m i n} \leq {υ}_{m} \leq {υ}_{m a x}$$

If all four checks are successful, quasi-masked coin data sets Zᵢ and Zⱼ become invalid and coin data set Zₘ becomes valid and correspondingly registered in monitoring entity 2.

Deletion of a coin data set in method 400 is not shown in FIGS. 12 and 13. For deletion, the terminal transmits a corresponding deletion command to the monitoring entity 2. In the monitoring entity 2, the signature of the issuing entity 1 created according to equation (65) is checked, and if it matches, invalidation occurs in the monitoring entity 2.

Within the scope of the invention, all elements described and/or drawn and/or claimed may be combined in any way.

### LIST OF REFERENCE SIGNS

1 issuing entity or bank
2 monitoring entity
21 command entry
22a, b entry of an electronic coin data set to be processed (predecessor)
23a, b entry of a processed electronic coin data set (successor)
24 signature entry
25 validation check marker
26 calculation check marker
27 area verification check marker
28 the signature check marker
3 direct transaction layer
4 monitoring layer
5 common wallet application
10, 10’ data storage
11 display
12 interface
13 computing unit
14 vault module
15 location detection module
M1 first terminal
M2 second terminal
M3 third terminal
Cᵢ electronic coin data set
Cⱼ, Cₖ split coin electronic data set,
C₁ electronic coin data set to be switched
Cₘ electronic coin data set to be combined/combined
Zᵢ masked electronic coin data set
Zⱼ, Zₖ masked split electronic coin partial data set
Zₗ masked electronic coin data set to be switched
Zₘ masked electronic coin data set to be combined
υᵢ, monetary amount
υⱼ, υⱼ split monetary amount
υₗ, monetary amount of an electronic coin data set to be switched
υₘ, monetary amount of an electronic coin data set to be combined
rᵢ obfuscation amount, Random number
rⱼ, rⱼ obfuscation amount of a split electronic coin data set
rₘ obfuscation amount of an electronic coin data set to be combined / a combined electronic coin data set
Cᵢ^{∗} transferred electronic coin data set
Cⱼ^{∗}, Cₖ^{∗} transferred coin partial electronic data set,
Zᵢ^{∗} masked transferred electronic coin data set
Zⱼ^{∗}, Zₖ^{∗} masked transferred split electronic coin data set
f(C) (homomorphic) one-way function
[Zᵢ]Sig signature of issuing entity
Sig public verification key of the signature
sig private signature key of the signature
w random number
e, p element of the ring signature
x Default value
101-108 Method steps according to an embodiment example
201-208 Process steps according to an embodiment example
301-309 Method steps according to an embodiment example
401-407 Method steps according to an embodiment example

1-27. (canceled)

28. A method for directly transferring electronic coin data sets between terminals,
wherein a first terminal has at least one electronic coin data set,
wherein the at least one electronic coin data set has a monetary amount and an obfuscation amount, comprising the steps of:
determining a masking mode from at least two masking modes,
wherein a first masking mode comprises:
masking the electronic coin data set, in the first terminal, by applying a one-way function, e.g. homomorphic, to the electronic coin data set, to its obfuscation amount for obtaining a fully masked electronic coin data set; and
transmitting a masked electronic coin data set to a monitoring entity for registering the masked electronic coin data set.

29. The method according to claim 28, wherein:
a second masking mode comprises:
masking the electronic coin data set, in the first terminal, by applying the one-way function to the electronic coin data set and adding a coin data set element, the monetary amount, of the electronic coin data set to obtain an incompletely masked electronic coin data set; or
a third masking mode comprises: masking the obfuscation amount of the electronic coin data set, in the first terminal, by applying cryptographic function to one of the data set elements, the obfuscation amount, of the electronic coin data set and adding a coin data set element, the monetary amount, of the electronic coin data set to obtain a quasi-masked electronic coin data set; or
a fourth masking mode comprises: splitting, by place value, the monetary amount of the electronic coin data set, in the first terminal, into a first monetary amount part and a second monetary amount part, the base of the place value being arbitrary;
replacing the monetary amount by the first monetary amount part in the electronic coin data set;
masking the electronic coin data set, in the first terminal, by applying the one-way function to the electronic coin data set and adding the second monetary amount part to obtain a partially masked electronic coin data set.

30. The method according to claim 29, wherein the step of registering is either registering the fully masked electronic coin data set or the incompletely masked electronic coin data set or the quasi-masked electronic coin data set or the partially masked electronic coin data set in the monitoring entity, depending on the determined masking mode.

31. The method according to claim 28, wherein the step of determining is performed by selecting the masking mode in the first terminal.

32. The method according to claim 31, wherein a parameter for determining the masking mode is provided by the monitoring entity or a service provider and the terminal selects the masking mode based on said parameter.

33. The method according to claim 28, wherein the step of determining is performed by selecting the masking mode in the monitoring entity or by a service provider.

34. The method according to claim 28, wherein the masking mode for an electronic coin data set is changed.

35. The method according to claim 28, comprising the further method steps:
generating a signature using the obfuscation amount of the electronic coin data set; and
adding the signature to the masked electronic coin data set, in particular the incompletely masked electronic coin data set or the quasi-masked electronic coin data set,
wherein in the monitoring entity the fully masked electronic coin data set or the incompletely masked electronic coin data set or the quasi-masked electronic coin data set is registered with the signature.

36. The method according to claim 28, comprising the further method steps:
switching the electronic coin data set while generating an electronic coin data set to be switched, in the first terminal, from the electronic coin data set,
wherein an obfuscation amount for the electronic coin data set to be switched is generated using the obfuscation amount of the electronic coin data set, in the first terminal and the monetary amount of the electronic coin data set is used as a monetary amount for the electronic coin data set to be switched; and/or
splitting the electronic coin data set into a first electronic coin partial data set and a second electronic coin partial data set, in the first terminal,
wherein the monetary amount is split into at least a first monetary amount and a second monetary amount; and/or or
combining a first and a second electronic coin data set into a combined electronic coin data set in the first terminal, comprising the steps of:
calculating an obfuscation amount for the electronic coin data set to be combined by forming the sum of the respective obfuscation amounts of the first and second electronic coin data sets; and
calculating the monetary amount for the electronic coin data set to be combined by forming the sum of the respective monetary amounts of the first and second electronic coin data sets;
wherein masking the electronic coin data set in the masking step of the first, second or fourth masking mode comprises masking the coin data set to be switched, the first and/or second coin partial data set and/or the linked coin data set or
wherein masking the data set element, the obfuscation amount, of the electronic coin data set comprises masking the data set element, the obfuscation amount, of the coin data set to be switched, the data set element, the obfuscation amount, of the first and/or the data set element the obfuscation amount, of the second coin partial data set and/or the data set element, the obfuscation amount, of the linked coin data set, and
transmitting the fully masked electronic coin data set or the incompletely masked electronic coin data set or the quasi-masked electronic coin data set or the partially masked electronic coin data set to the monitoring entity, from the first terminal, to the monitoring entity for checking the validity of the electronic coin data set by the monitoring entity.

37. The method according to claim 36, wherein the masking mode for an electronic coin data set is changed by switching the electronic coin data set.

38. The method according to claim 36, wherein after the switching step, the registering step in the monitoring entity comprises for the first and/or fourth masking mode:
receiving the incompletely masked electronic coin data set to be switched or the fully masked electronic coin data set to be switched or the partially masked electronic coin data set in the monitoring entity;
checking the masked electronic coin data set for validity in the monitoring entity;
calculating the difference between the incompletely masked coin data set to be switched or the fully masked coin data set to be switched or the partially masked electronic coin data set and the masked electronic coin data set to check whether the monetary amount of the electronic coin data set is equal to the monetary amount of the electronic coin data set to be switched;
checking by means of a signature added to the incompletely masked electronic coin data set or to the fully masked electronic coin data set generated by generating a public verification key;
checking a full or abbreviated range verification; and
registering the masked electronic coin data set to be switched in the monitoring entity if the checking steps are successful and a simplified range verification has been performed,
wherein the electronic coin data set to be switched is deemed valid.

39. The method according to claim 36, wherein after the splitting step, the registering step comprises, in the monitoring entity for the first, second and/or fourth masking mode:
receiving the incompletely masked electronic coin partial data sets or the fully masked electronic coin partial data sets or the partially masked electronic coin partial data sets in the monitoring entity;
checking the masked electronic coin data set to be switched for validity in the monitoring entity;
checking a ring signature added to the incompletely masked electronic coin partial data sets or to the partially masked electronic coin partial data sets using the monetary amount of the electronic coin data set in the monitoring entity;
calculating the difference between the sum of the incompletely masked electronic coin data sets or the fully masked electronic coin data sets or the partially masked coin data sets and the masked coin data set for checking whether the monetary amount of the electronic coin partial data set is equal to the sum of the first and second monetary amounts of the electronic coin partial data sets;
registering the masked electronic coin data sets in the monitoring entity if the three checking steps are successful and a simplified range verification has been performed on the incompletely masked coin data sets or the quasi-masked coin data sets or the partially masked coin data sets, wherein the electronic coin data sets are considered valid.

40. The method according to claim 36, wherein after the step of combining, the step of registering comprises, in the monitoring entity for the first, second and/or fourth masking mode:
receiving the incompletely or fully or partially masked connected electronic coin data set in the monitoring entity;
checking the masked first and second electronic coin data sets for validity in the monitoring entity;
checking a first ring signature added to the incompletely masked first electronic coin data set or to the partially masked first electronic coin data set using the first monetary amount of the first electronic coin data set in the monitoring entity;
checking a second ring signature added to the incompletely masked second electronic coin data set or to the fully masked second electronic coin data set using the second monetary amount of the second electronic coin data set in the monitoring entity;
calculating the difference between the incompletely masked linked electronic coin data set or the fully masked linked electronic coin data set and the sum of the masked first electronic coin data set and the masked second electronic coin data set to check whether the monetary amount of the linked electronic coin data set is equal to the sum of the first and second monetary amounts of the first and second electronic coin data sets;
registering the masked linked electronic coin data set in the monitoring entity if the three checking steps are successful and a simplified range verification has been performed, wherein the linked electronic coin data set is deemed valid.

41. The method according to claim 36, wherein after the switching step, the registering step in the monitoring entity comprises for the third masking mode:
receiving the quasi-masked electronic coin data set to be switched in the monitoring entity;
checking the quasi-masked electronic coin data set for validity in the monitoring entity;
checking a signature added to the quasi-masked electronic coin data set using the encrypted obfuscation amount of the electronic coin data set in the monitoring entity; and
registering the quasi-masked electronic coin data set to be switched in the monitoring entity if the two checking steps are successful, wherein the electronic coin data set to be switched is deemed valid.

42. The method according to claim 36, wherein after the splitting step, the registering step in the monitoring entity for the third masking mode comprises:
receiving the quasi-masked electronic coin partial data set in the monitoring entity;
checking the quasi-masked electronic coin data set for validity in the monitoring entity;
checking a signature added to the quasi-masked electronic coin partial data set using the masked obfuscation amount in the monitoring entity;
checking that the monetary amount of the electronic coin partial data set is equal to the sum of the first and second monetary amounts of the electronic coin partial data sets;
registering the quasi-masked coin partial electronic data sets in the monitoring entity if the three checking steps are successful, thereby registering the coin partial electronic data sets as valid and the coin partial electronic data set to be split as invalid.

43. The method according to claim 36, wherein after the step of combining, the step of registering comprises, in the monitoring entity for the third masking mode:
receiving the quasi-masked connected electronic coin data set in the monitoring entity;
checking the quasi-masked first and second electronic coin data sets for validity in the monitoring entity;
checking two signatures added to the quasi-masked linked electronic coin data sets to be combined using the masked obfuscation amounts in the monitoring entity;
checking that the monetary amount of the linked electronic coin data set is equal to the sum of the first and second monetary amounts of the first and second electronic coin data sets;
registering the quasi-masked combined electronic coin data set in the monitoring entity if the three checking steps are successful, wherein the combined electronic coin data set is deemed valid and the two electronic coin data sets to be combined are deemed invalid.

44. The method according to claim 35, wherein the added signature is a first signature and a private signature key for generating the first signature is the obfuscation amount of the electronic coin data set.

45. The method according to claim 35, wherein the added signature is a second signature and a private signature key for generating the second signature is formed from a difference of the obfuscation amount of the electronic coin data set and the obfuscation amount for the electronic coin data set to be switched.

46. The method according to claim 44, wherein a public verification key for checking the first signature is formed from a difference of the masked electronic coin data set and applying the cryptographic encryption function to the monetary amount of the electronic coin data set.

47. The method according to claim 44, wherein a public verification key for checking the second signature is formed from a difference between the incompletely masked electronic coin data set and the masked electronic coin data set.

48. The method according to claim 28, wherein the at least one electronic coin data set has been generated by an issuing entity,
wherein the issuing entity signs a completely or partially or incompletely or quasi-masked electronic coin data set with its signature, and
wherein this signature is deposited in the monitoring entity.

49. A payment system for exchanging monetary amounts, the payment system comprising:
a monitoring layer comprising a decentrally controlled database, Distributed Ledger Technology, DLT, in which fully masked electronic coin data sets or incompletely masked electronic coin data sets or quasi-masked electronic coin data sets are stored; and
a direct transaction layer comprising at least two terminals, in which the method according to claim 28 can be performed; and/or
an issuing entity for generating an electronic coin data set and a signature, the signature being stored in the database.

50. The currency system comprising an issuing entity, a monitoring entity, a first terminal and a second terminal,
wherein an issuing entity is adapted to create an electronic coin data set,
wherein a fully masked electronic coin data set or an incompletely masked electronic coin data set or a quasi-masked electronic coin data set is adapted to be detectably created by the issuing entity,
wherein the monitoring entity is adapted to perform a registration step according to claim 28.

51. The currency system according to claim 50, wherein the first and second terminals are adapted to perform the method for directly transferring electronic coin data sets between terminals.

52. The currency system according to claim 50, wherein the verifying entity and the issuing entity are implemented as a server entity, in particular as a computer program product on a server and/or a computer.

53. The currency system according to claim 50, wherein the first and/or second terminal is designed as a mobile terminal, in particular as a smartphone, a tablet computer, a computer, a server or a machine, and/or as a passive terminal, in particular smart card or as a wearable.

54. A monitoring unit set up to:
receiving a masked electronic coin data set; and
registering the masked electronic coin data set,
wherein the masked electronic coin data set is masked in a first masking mode or a second masking mode, according to masking steps from the method of claim 28.
